(19) United States
(12) Patent Application Publication
(10) Pub. No.: US 2025/0088323 A1
(43) Pub. Date: Mar. 13, 2025

(54) REFERENCE SIGNAL ASSIGNMENT

(71) Applicant: Huawei Technologies Co., Ltd., Shenzhen (CN)

(72) Inventors: Yiqun Ge, Kanata (CA); Wuxian Shi, Kanata (CA); Wen Tong, Ottawa (CA)

(21) Appl. No.: 18/956,809

(22) Filed: Nov. 22, 2024

Related U.S. Application Data
(63) Continuation of application No. PCT/CN2022/094688, filed on May 24, 2022.

(51) Int. Cl. H04L 5/00; H04L 25/02

(52) U.S. Cl. CPC H04L 5/0048; H04L 25/0224

(57) ABSTRACT

Aspects of the present disclosure relate to a reference signal assignment, in which reference signals for a first apparatus may be assigned based on second channel estimates for one or more second apparatus having a same location and network resource configuration as the first apparatus.

### CROSS-REFERENCE TO RELATED APPLICATION

This application is a continuation of International Application No. PCT/CN2022/094688, filed on May 24, 2022, which is hereby incorporated by reference in its entirety.

### TECHNICAL FIELD

This application relates to wireless communications technology and, in particular, to the assignment of one or more reference signals to one or more network resources.

### BACKGROUND

In wireless communication networks, the characteristics of a channel can be estimated by using reference signals known to the transmitter and the receiver. The receiver can estimate the channel by measuring reference signals received from the transmitter and comparing the measurements with the known signals.

### SUMMARY

Communication networks typically adopt a number of reference signal placement schemes, in which reference signals are uniformly distributed across network resources with a density depending on the variability of the channel. According to the Nyquist Sampling Theorem, in order to adequately capture variations in a channel, the channel should be sampled at a uniform sampling frequency which is at least twice the maximum frequency of variations in the channel. As a result, the density of reference signals (e.g., the number of reference signals assigned per unit of network resource) is determined by the parts of the channel (e.g., a particular frequency range, one or more symbols etc.) which undergo the worst distortions. This can lead to an excess of reference signals being transmitted in parts of the channel which undergo fewer variations, even though a smaller number of reference signals would have been sufficient to sample those parts of the channel.

Aspects of the present disclosure relate to an adaptive reference signal assignment, in which reference signals for a first apparatus may be assigned based on the location and configuration of network resources for the first apparatus. The assignment may be further based on channel estimates for one or more second apparatus that are near to, or in the same region as the first apparatus and have the same configuration of network resources. The channel estimates may characterise the expected channel for the first apparatus. Thus, for example, the channel estimates may indicate the variability of the channel of the first apparatus across the network resources configured for the first apparatus. The channel estimates may, for example, indicate that the channel is more variable (e.g., more selective) across one transmission dimension (e.g., time) compared to another transmission dimension (e.g., frequency). This detailed insight allows for adapting reference signal assignment for the first apparatus based on the expected characteristics of the channel. This can enable accurately estimating the channel whilst minimizing the number of reference signals used. As such, this can make additional network resources available for data transmission, which allows for using network resources more efficiently. This may be particularly important for channels having a high number of degrees of freedom, since significantly increasing transmission degree-of-freedom in the data plane may increase control traffic. As such, aspects of the present disclosure may allow for improving data rates (e.g., by enable an increase in the number of degrees-of-freedom, or dimensions, of transmissions) whilst minimising control overhead.

In a first aspect, a method is provided. The method may comprise obtaining a first configuration defining a plurality of first network resources for transmissions to a first apparatus using a channel and obtaining an assignment of one or more reference signals to one or more second network resources from the plurality of first network resources. The assignment may be based on first channel estimates for one or more second apparatus having a same location and first configuration as the first apparatus. The method may further comprise transmitting one or more reference signals to the first apparatus using the one or more second network resources.

Obtaining the assignment may comprise obtaining one or more eigenvectors from a singular value decomposition of the first channel estimates and determining the assignment based on the one or more eigenvectors. Determining the assignment based on the one or more eigenvectors may comprise performing at least a partial pivoted QR decomposition of the one or more eigenvectors to assign the one or more reference signals to one or more second network resources.

Obtaining the first configuration may comprise obtaining a plurality of eigenvectors and selecting the one or more eigenvectors from the plurality of eigenvectors based on at least one of: a rank of the one or more eigenvectors and a sparsity of the one or more eigenvectors. The plurality of eigenvectors may comprise, for each of a plurality of configurations, one or more respective eigenvectors from a singular value decomposition of respective second channel estimates for one or more third apparatus having the same location. Obtaining the first configuration may further comprise identifying, from the plurality of configurations, the first configuration associated with the one or more eigenvectors.

The method may further comprise receiving, from the first apparatus, one or more coefficients determined based on measurements of the one or more reference signals, and determining an estimate of the channel based on the one or more coefficients and the one or more eigenvectors.

The first configuration may define the plurality of first network resources in a plurality of dimensions. The plurality of dimensions may comprise at least two of the following: frequency, time, space, and transmission code.

The first configuration may indicate at least one of: a subcarrier spacing, a symbol duration, a configuration of one or more transmit antennas and one or more receive antennas, a code. The one or more second apparatus may have a same category as the first apparatus, wherein the category indicates a capability of the first apparatus.

The method may further comprise, prior to transmitting the one or more reference signals to the second apparatus, transmitting, to the second apparatus, a number of the one or more reference signals. The method may further comprise, responsive to a request from the first apparatus, transmitting, to the first apparatus, one or more further reference signals using one or more further network resources. The one or more further network resources may be selected from the plurality of first network resources based on the first channel estimates. The one or more further reference signals may outnumber the one or more reference signals.

An apparatus configured to perform any one of the aforementioned methods is also provided. A memory storing instructions is also provided. The instructions, when executed by a processor, may cause the processor to perform any one of the aforementioned methods.

In a second aspect, a method performed by a first apparatus is provided. The method may comprise obtaining a first configuration defining a plurality of first network resources for transmissions to the first apparatus using a channel and obtaining an assignment of one or more reference signals to one or more second network resources selected from the plurality of first network resources. The assignment may be based on based on first channel estimates for one or more second apparatus having a same location and first configuration as the first apparatus. The method may further comprise measuring one or more reference signals received on the one or more second network resources.

Obtaining the assignment may comprise obtaining one or more eigenvectors from a singular value decomposition of the first channel estimates and determining the assignment based on the one or more eigenvectors. Determining the assignment based on the one or more eigenvectors may comprise performing at least a partial pivoted QR decomposition of the one or more eigenvectors to select the one or more second network resources from the plurality of first network resources for reception of the one or more reference signals.

The method may further comprise receiving an indication of a number of the one or more reference signals to be received, and selecting the one or more second network resources from the plurality of first network resources based on the at least partial QR decomposition and the number of the one or more reference signals.

The method may further comprise determining a sampled channel estimate based on the measurement of the one or more reference signals, determining, based on the sampled channel estimate and the one or more eigenvectors, one or more coefficients, and sending the one or more coefficients to the second apparatus. The sampled channel estimate may correspond to an estimate of the first channel at the one or more second network resources.

The method may further comprise determining a sampled channel estimate based on the measurement of the one or more reference signals, determining one or more coefficients based on the sampled channel estimate and the one or more eigenvectors, and determining, based on the coefficients and the sampled channel estimate, an estimate of the channel at the plurality of first network resources. The sampled channel estimate may correspond to an estimate of the first channel at the one or more second network resources.

The method may further comprise determining a channel estimate based on the measurement of the one or more reference signals, and responsive to the channel estimate failing to satisfy a criterion, transmitting a request for transmission of an increased number of reference signals.

A first apparatus configured to perform any one of the aforementioned methods is also provided. A memory storing instructions is also provided. The instructions, when executed by a processor of the first apparatus, may cause the processor to perform any one of the aforementioned methods.

In a third aspect, an apparatus is provided. The apparatus may comprise a memory storing instructions and a processor. The processor may be caused, by executing the instructions, to obtain a first configuration defining a plurality of first network resources for transmissions to a first apparatus using a channel and obtain an assignment of one or more reference signals to one or more second network resources from the plurality of first network resources. The assignment may be based on first channel estimates for one or more second apparatus having a same location and first configuration as the first apparatus. The processor may be further caused to transmit one or more reference signals to the first apparatus using the one or more second network resources.

The processor may be further caused to obtain the assignment by obtaining one or more eigenvectors from a singular value decomposition of the first channel estimates and determining the assignment based on the one or more eigenvectors. The processor may be further caused to determine the assignment based on the one or more eigenvectors by performing at least a partial pivoted QR decomposition of the one or more eigenvectors to assign the one or more reference signals to one or more second network resources.

The processor may be further caused to obtain the first configuration by obtaining a plurality of eigenvectors, and selecting one or more eigenvectors from the plurality of eigenvectors based on at least one of: a rank of the one or more eigenvectors and a sparsity of the one or more eigenvectors. The plurality of eigenvectors may comprise, for each of a plurality of configurations, one or more respective eigenvectors from a singular value decomposition of respective second channel estimates for one or more third apparatus having the same location. The processor may be further caused to obtain the first configuration by identifying, from the plurality of configurations, the first configuration associated with the one or more eigenvectors.

The processor may be further caused to receive, from the first apparatus, one or more coefficients determined based on measurements of the one or more reference signals, and determine an estimate of the channel based on the one or more coefficients and the one or more eigenvectors.

The first configuration may define the plurality of first network resources in a plurality of dimensions. The plurality of dimensions may comprise at least two of the following: frequency, time, space, and transmission code. The first configuration may indicate at least one of: a subcarrier spacing, a symbol duration, a configuration of one or more transmit antennas and one or more receive antennas, and a code. The one or more second apparatus may have a same category as the first apparatus, wherein the category indicates a capability of the first apparatus.

The processor may be further caused to, prior to transmitting the one or more reference signals to the second apparatus, transmit, to the second apparatus, a number of the one or more reference signals.

The processor may be further caused to, responsive to a request from the first apparatus, transmit, to the first apparatus, one or more further reference signals using one or more further network resources selected from the plurality of first network resources based on the first channel estimates. The one or more further reference signals may outnumber the one or more reference signals.

In a fourth aspect, a first apparatus is provided. The first apparatus may comprise a memory storing instructions and a processor. The processor may be caused, by executing the instructions, to obtain a first configuration defining a plurality of first network resources for transmissions to the first apparatus using a channel, and obtain an assignment of one or more reference signals to one or more second network resources selected from the plurality of first network resources. The assignment may be based on based on first channel estimates for one or more second apparatus having a same location and first configuration as the first apparatus. The processor may be further caused to measure one or more reference signals received on the one or more second network resources.

The processor may be further caused to obtain the assignment by obtaining one or more eigenvectors from a singular value decomposition of the first channel estimates and determining the assignment based on the one or more eigenvectors. The processor may be further caused to determine the assignment based on the one or more eigenvectors by performing at least a partial pivoted QR decomposition of the one or more eigenvectors to select the one or more second network resources from the plurality of first network resources for reception of the one or more reference signals. The processor may be further caused to receive an indication of a number of the one or more reference signals to be received, and select the one or more second network resources from the plurality of first network resources based on the at least partial QR decomposition and the number of the one or more reference signals.

The processor may be further caused to determine a sampled channel estimate based on the measurement of the one or more reference signals, determine, based on the sampled channel estimate and the one or more eigenvectors, one or more coefficients, and send the one or more coefficients to the second apparatus. The sampled channel estimate may correspond to an estimate of the first channel at the one or more second network resources.

The processor may be further caused to determine a sampled channel estimate based on the measurement of the one or more reference signals, determine, based on the sampled channel estimate and the one or more eigenvectors, one or more coefficients and determine, based on the coefficients and the sampled channel estimate, an estimate of the channel at the plurality of first network resources. The sampled channel estimate may correspond to an estimate of the first channel at the one or more second network resources.

The processor may be further caused to determine a channel estimate based on the measurement of the one or more reference signals and responsive to the channel estimate failing to satisfy a criterion, transmit a request for transmission of an increased number of reference signals.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the disclosure may occur;

FIG. 2 is another schematic diagram of a communication system in which embodiments of the disclosure may occur;

FIG. 3 is a block diagram illustrating units or modules in a device in which embodiments of the disclosure may occur;

FIG. 4 is a block diagram illustrating units or modules in a device in which embodiments of the disclosure may occur;

FIG. 5 shows a signalling diagram of a method according to embodiments of the disclosure;

FIG. 6 shows an example of a cell served by a transmit and receive point according to embodiments of the disclosure;

FIG. 7 shows example configurations for a channel according to embodiments of the disclosure;

FIGS. 8A, 8B and 8C illustrates an example method for determining eigenvectors and singular values according to embodiments of the disclosure;

FIG. 9 shows a flowchart of a method according to embodiments of the disclosure;

FIG. 10 shows a signalling diagram of a method according to embodiments of the disclosure;

FIG. 11 shows methods of determining coefficients according to embodiments of the disclosure;

FIGS. 12 and 13 show signalling diagrams of methods according to embodiments of the disclosure; FIG. 14A shows an allocation of network resources;

FIG. 14B shows an allocation of network resources according to embodiments of the disclosure;

FIG. 15 shows a flowchart of a method according to embodiments of the disclosure; and

FIG. 16 shows a flowchart of a method according to embodiments of the disclosure.

### DETAILED DESCRIPTION OF THE EMBODIMENTS

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

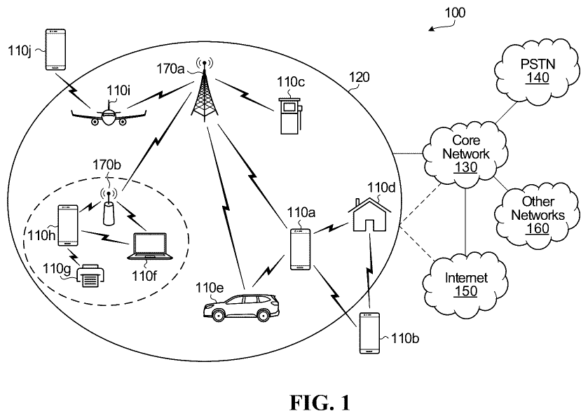

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electronic device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

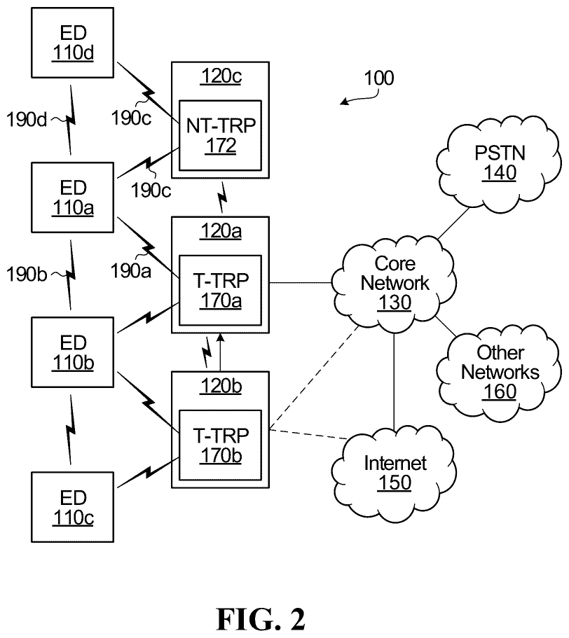

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

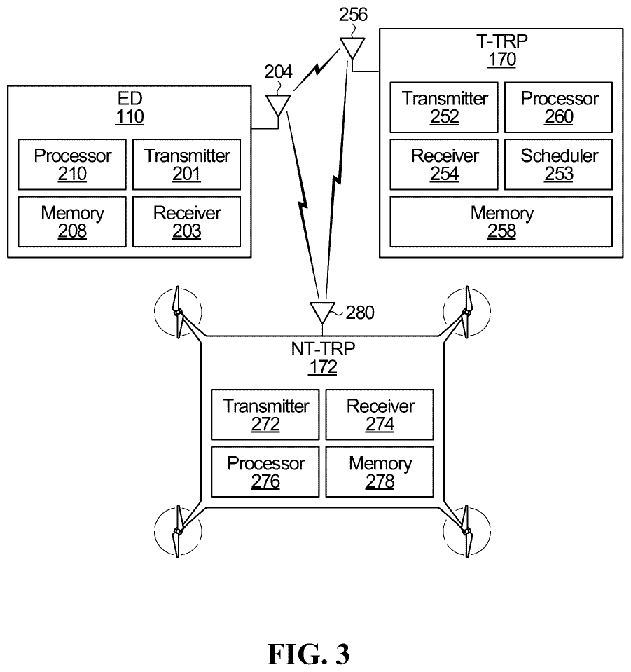

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

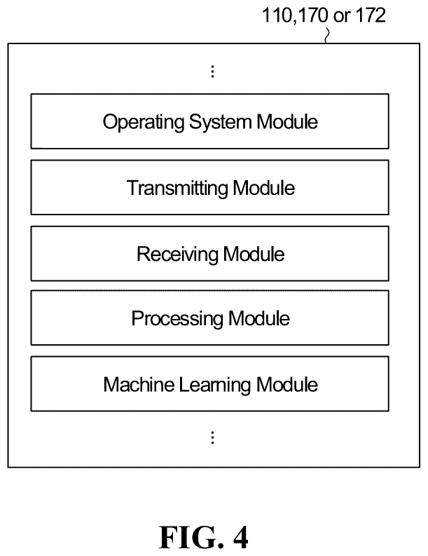

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Reference signals for measuring the characteristics of a channel are typically assigned to network resources by according to a reference signal placement scheme in which the density of reference signals is determined by the most variable part of the channel. This can lead to more reference signals being transmitted than is necessary. Aspects of the present disclosure provide an adaptive reference signal assignment method, in which references signals for an apparatus may be assigned based on channel estimates for other apparatus sharing a same location and network resource configuration. This allows for adapting reference signal assignment based on the expected characteristics of the channel. In particular, this may allow for determining non-uniform reference signal placement schemes, in which the density of reference signals may vary across the channel according to channel characteristics.

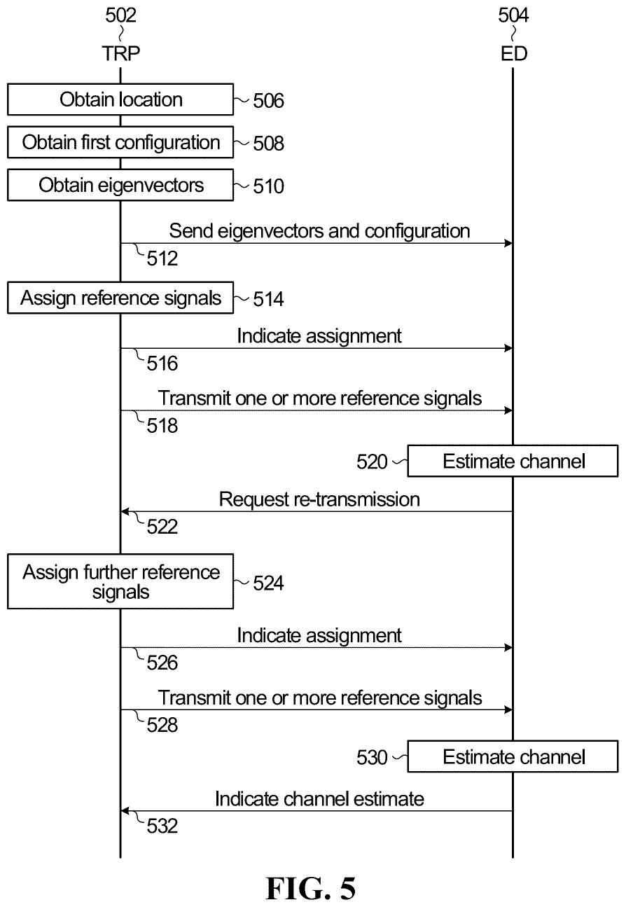

FIG. 5 shows a signalling diagram of a method 500 performed by a TRP 502 and a first electronic device 504 according to embodiments of the disclosure.

The TRP 502 may comprise any suitable TRP such as, for example, any of the T-TRPs 170a, 170b or the NT-TRP 172 described above in respect of FIGS. 1-4. Thus, for example, the TRP 502 may comprise a base station.

The first electronic device 504 may comprise any suitable electronic device such as, for example, any of the electronic devices 110 described above in respect of FIGS. 1-4.

The TRP 502 and the first electronic device 504 may be in a communications system such as, for example, the communications system 100 described above in respect of FIGS. 1-4.

In step 506, the TRP 502 may obtain a location of the first electronic device 504. The location may indicate that the first electronic device is in a particular geographic area or region. Thus, for example, the location may comprise an identifier of a particular region. The location may indicate that the first electronic device is in a particular cell and/or a particular region within the cell. In particular examples, the TRP 502 may serve a cell and the cell may be divided into a plurality of sub-regions (e.g., into a grid). The location of the first electronic device 504 may comprise an identifier for the particular sub-region in which the electronic device 504 is located. For example, the location may comprise an identifier of the particular sub-region. The sub-regions may be overlapping or non-overlapping. The size of the sub-regions may depend on a frequency (or, equivalently, wavelength) of the first electronic device 504. For example, the size of the sub-regions may depend on a frequency or wavelength over which the first electronic device 504 is operable to receive transmissions from the TRP 502. In particular examples, sub-regions may be smaller for high frequencies (or shorter wavelengths).

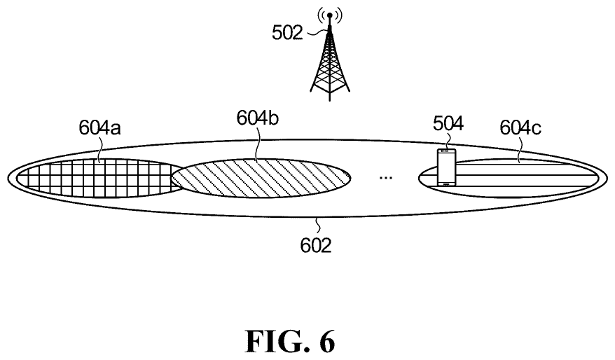

An example of a cell 602 served by the TRP 502 being divided into a plurality of subregions is shown in FIG. 6. In this example, the electronic device 504 is connected to the cell 602 served by the TRP 502. The cell is divided into a plurality of grids 604 (e.g., sub-regions), of which a first grid 604a, a second grid 606b and a third grid 604c are shown. The grids may be labelled as Grid-g[1], Grid-g[2], . . . Grid-g[y], for example. In this example, the first grid 604a and the second grid 604b overlap. In other examples, some or all of the grids might not overlap. The electronic device 504 is in the third grid 604c. Thus, the TRP 502 may, in step 506 obtain an indication that the electronic device 504 is in the third grid 604c. The TRP 502 may, for example, obtain (e.g., receive or determine) an identifier for the third grid 604c. In an example, the TRP 502 may obtain a location measurement of the electronic device 504 and, based on the measurement, determine that the electronic device 504 is in the third grid 604c.

In step 508, the TRP 502 obtains a first configuration defining a plurality of first network resources for transmissions to the electronic device 504 using a first channel. The first channel may be between the TRP 502 and the electronic device 504.

The first configuration may define the plurality of first network resources in one or more dimensions. In particular examples, the first configuration may define the plurality of first network resources in two or more (e.g., a plurality of) dimensions. According to the first configuration, one or more divisions may be defined for each dimension to divide (e.g., stratify or discretize) the channel into network resources. A dimension may represent a way in which the channel may be shared (e.g., by multiple transmitters and/or multiple receivers).

Those skilled in the art will appreciate that there are various ways in which a channel may be divided (e.g. stratified or discretized) into network resources. For example, in some communication networks, a channel may be divided into a plurality of resource elements, in which each resource element has a bandwidth of one subcarrier and a time duration of one symbol. The resource element is an example of a network resource defined by a configuration (subcarrier spacing over frequency dimension and symbol duration over timing dimension for example).

More generally, there are a number of dimensions along which a channel may be divided. For example, third generation (3G) networks introduce code as a transmission dimension (e.g., using code division multiple access, CDMA, technology). Fourth generation (4G) networks introduced a spatial dimension (e.g., using multiple input multiple output, MIMO, antenna system technology). Further dimensions may be conceived as technology continues to progress.

For a particular dimension, the first configuration may indicate a resolution (e.g., an increment) or grouping that is used to divide the channel in that dimension. For the example of resource elements described above, the first configuration may indicate resolutions (e.g., subcarrier spacing and symbol duration) used to divide the channel in two dimensions (e.g., frequency and time).

The skilled person will appreciate that there are various dimensions, and thus associated first configurations, which may be used. Examples of suitable dimensions include time, frequency, space (e.g., using multiple antennas) and transmission code.

As noted above, a first configuration associated with a time dimension may indicate a symbol duration. For example, the first configuration may indicate a symbol duration of 2 ms, 5 ms, 10 ms, or 20 ms. In another example, the first configuration may indicate a number of symbols such as, for example, a number of symbols per unit time. The first configuration may indicate a number of symbols per slot, subframe, half-frame or frame, for example. For example, the first configuration may indicate 10 symbols per 10 millisecond subframe. In another example, the first configuration may indicate 20 symbols per 10 millisecond subframe.

A first configuration associated with a frequency dimension may indicate a subcarrier spacing. In another example, the first configuration associated with a frequency dimension may indicate a number of subcarriers. For example, the first configuration may indicate a number of subcarriers within a particular bandwidth or a particular bandwidth part of the channel. For example, the first configuration may indicate that 514, 1024, or 2048 sub-carriers are to be used (e.g., for a 5 MHz, 10 MHz, or 20 MHz bandwidth).

Transmission code may refer to coding schemes for multiple access. For example, transmission code may refer to a coding scheme for enabling multiple apparatus (e.g., multiple electronic devices) to share a channel. Thus, the first configuration associated with a transmission code dimension may indicate a particular coding scheme such as, for example, one or more codes for (e.g., assigned or to be assigned to) one or more transmitters.

Space may refer to methods for transmitting and/or receiving more than one signal simultaneously over the same channel by using multipath propagation (e.g., using multiple antennas). Thus, the configuration associated with a space dimension may indicate one or more multiple input multiple output (MIMO) parameters which may be used to divide the channel into the plurality of network resources. For example, the configuration associated with a space dimension may indicate a configuration of one or more transmit antennas (e.g., at the TRP 502) and one or more receive antennas (e.g., at the electronic device 504).

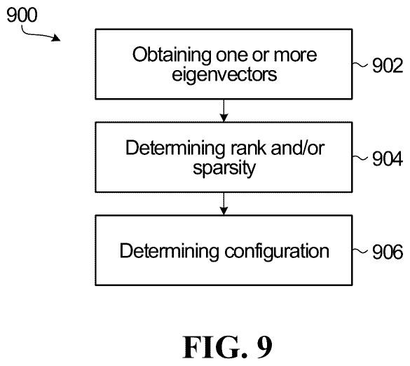

The TRP 502 may be configured with the first configuration. Alternatively, the TRP 502 may receive the first configuration. In some examples, the TRP 502 may determine the first configuration. An example method for determining a configuration, such as the first configuration, is described below in respect of FIG. 9. The TRP 502 may receive a request, from the electronic device 504 for a first configuration and determine the first configuration (e.g., responsive to the request). The request may specify a particular number of m network resources to be defined by the first configuration. m may equivalently be referred to as the degree of freedom of transmissions made by the first apparatus 504. The request may be referred to as a degree of freedom request, for example.

In step 510, the TRP 502 obtains one or more eigenvectors w from a singular value decomposition (SVD) of first channel estimates for one or more second electronic devices. The first channel estimates comprise, for each of the one or more second electronic devices, at least one respective channel estimate.

The one or more second electronic devices may comprise any suitable electronic devices. In particular examples, they may comprise one or more electronic devices that were or are connected to the TRP 502. For example, the channel estimates and/or the one or more eigenvectors may be specific to the TRP 502. In an example, the one or more second electronic devices and the first electronic device may be a same type of electronic device. Exemplary types of electronic device may include, for example: a user equipment (UE), a machine type communication (MTC) device, a vehicle or an Internet of Thing (IoT) device.

The at least one channel estimate for a respective second electronic device comprises an estimate of a channel over which the respective second electronic device was or is operable to receive signals. The channel may be between the TRP 502 and the respective second electronic device, for example.

The at least one channel estimate for a respective second electronic device may be based on one or more measurements performed by the respective second electronic device on one or more reference signals received by the respective second electronic device. For example, the at least one channel estimate may be based on measurements on two or more reference signals received by the respective second electronic device. The skilled person will appreciate that there are various ways in which such measurements can be used to estimate a channel and thus this is not discussed in detail here.

The one or more second electronic devices have the same first configuration as the first electronic device 504. As such, the at least one channel estimate for a respective second electronic device may be based on measurements of one or more reference signals transmitted on one or more network resources for the respective second electronic device, in which the one or more network resources are defined by the same first configuration. For example, each of the at least one channel estimate for a respective second electronic device may be based on a measurement of a reference signal transmitted on a network resource defined, by the same first configuration, for the respective second electronic device

The one or more second electronic devices have a same location as the first electronic device 50 (e.g., the same as the location obtained in step 506). In this context, the location of the second electronic devices may be the location of the second electronic devices when the first channel estimates were determined. The locations of the one or more second electronic devices may thus alternatively be referred to as the locations associated with the first channel estimates. For example, the location of a respective second electronic device may be the location of the respective second electronic device when the second electronic device performs measurements on one or more reference signals, in which the measurements are used (e.g., by the respective second electronic device) to determine the respective at least one channel estimate.

The skilled person will appreciate that the reference to the same location may mean that one or more second electronic devices may or might not be in precisely the same location as the first electronic device 504 (e.g., at exactly the same coordinates). The second electronic devices may be in a same region as the first electronic device 504. For example, the one or more second electronic devices may be in a same cell as the first electronic device 504. The one or more second electronic devices and the first electronic device 504 may be in the same sub-region of the cell. In the example shown in FIG. 6, the one or more second electronic devices may be or have been in the third grid 604c, for example. In some examples, the one or more second electronic devices may be or have previously been within a threshold distance of the location of the first electronic device 504 (e.g., the second electronic devices may be near to the first electronic device 504). In some examples, the one or more second electronic devices may be the closest electronic devices to the location of first electronic device 504. For example, the one or more second electronic devices may comprise the N electronic devices that are or have been closest to the location of the first electronic device (e.g., for which channel estimates are available).

As the channel between a TRP and an electronic device may be affected by the surroundings (e.g. the neighbouring physical landscape) of the TRP and the electronic device, the channel between the TRP and the electronic device may vary depending on the position of the electronic device. There may be some commonalities among channels between the TRP and electronic devices in a similar location (e.g., electronic devices near to each other). These commonalities may vary very slowly or stay persistently. The channel for an electronic device in a similar location (e.g., near to these electronic devices) is likely to share these commonalities. In addition, since channel estimates are determined based on measurements of reference signals, channel estimates effectively represent discrete samples of the channel. This means that estimates of a channel can vary depending on the network resources over which the reference signals used to determine the channel are sent. Therefore, dependencies may be expected to arise between channel estimates for electronic devices, the location of the electronic devices, and the configurations defining network resources for the electronic devices. As a result of these commonalities, the reference signal position pattern for a first electronic device may be determined by channel estimates for a one or more second electronic devices.

An SVD may be used to obtain (e.g., capture) the commonalities between channel estimates for electronic devices sharing a common location and/or network resource configuration. As such, in step 510, one or more eigenvectors are obtained from an SVD performed on the first channel estimates. The one or more eigenvectors may characterize variations in the first channel estimates across the network resources at which they were measured.

The SVD may be performed on a joint channel estimate matrix \tilde{h} (e.g., a joint vectorized channel estimate matrix) formed from the first channel estimates. The joint channel estimate matrix may be formed by, for each of the one or more second electronic devices, forming a tensor comprising the at least one channel estimate for the respective second electronic device. The tensor for a respective second electronic device may comprise m elements, in which m is the number of network resources defined by the first configuration D. m may equivalently be referred to as the degree of freedom of the configuration D. For example, a configuration indicating 1024 subcarriers and 10 symbols (e.g., 10 symbols per subframe, each symbol having a duration of 1 millisecond) may correspond to a 1024-by-10 tensor of channel estimates having m=1024×10=10240 elements. Each element of a respective tensor may correspond to a particular network resource defined by the first configuration D for the respective second electronic device. Each of element of a respective tensor may thus comprise a channel estimate representing a sample of a channel at the particular network resource. One or more of the elements of a respective tensor may be equal to zero (e.g., since channel estimates may not be obtained at each of the network resources defined by the configuration D).

Each tensor may have two or more dimensions. Each tensor may be reshaped into a vector (e.g., a column vector or a row vector) and used to form the matrix \tilde{h} of first channel estimates (e.g., by placing the vectors side-by-side to form the matrix). For example, a 1024-by-10 tensor comprising at least one channel estimate for a respective second electronic device may be reshaped into vector of length 10240 for inclusion in the matrix \tilde{h}.

The joint channel estimate matrix may be expressed as:
\tilde{h}=[\tilde{h}(1), \tilde{h}(2), . . . ,\tilde{h}(l)],
   in which each column, \tilde{h}(.), of the matrix comprises a column vector of length m and each column vector comprises at least one channel estimate for a respective second electronic device. In some examples, two or more column vectors in the matrix may be associated with the same second electronic device. For example, a first column vector may comprise at least one channel estimate for a respective second electronic device at a first time and a second column vector may comprise another at least one channel estimate for the respective second electronic device at a second time (e.g., a different time). The joint channel estimate matrix may have dimensions m×l.

An SVD may be applied to the joint channel estimate matrix \tilde{h} to decompose the joint channel estimate matrix into three matrices U, Σ and V⁻¹ in accordance with

$$\tilde{h} \approx u \sum {V}^{- 1} ,$$

in which U is an m by m matrix, Σ is an m by l matrix, and V⁻¹ is an l by l matrix. This may be referred to as a full-space SVD. U may be referred to as a left unitary matrix. Σ is a diagonal matrix. The diagonal entries of Σ are singular values of the joint channel estimate matrix \tilde{h}. The number of non-zero singular values of the joint channel estimate matrix is equal to its rank, r. The rank r of the joint vectorized channel estimate matrix \tilde{h} indicates the number of independent rows or columns (e.g., the number of principal independent rows or columns) in \tilde{h}. U comprises one or more eigenvectors corresponding to the one or more non-zero singular values of \tilde{h}. U may thus comprise r eigenvectors ψ=[ψ₁, . . . , ψᵣ] for a joint vectorized channel estimate matrix \tilde{h} with r (non-zero) singular values. In general, r<m. In particular examples, r<<m.

Therefore, the one or more eigenvectors [ψ₁, . . . , ψᵣ] may be obtained from an SVD of the first channel estimates.

In some examples, the one or more eigenvectors may be obtained from a compact SVD of the first channel estimates. The joint channel estimate matrix \tilde{h} may be formed as described above. A compact SVD may be applied to the joint channel estimate matrix \tilde{h} to decompose \tilde{h} in accordance with

$$\tilde{h} \approx ψ {\sum }_{c} {V}_{c}^{- 1} ,$$

in which ψ is an m by r matrix, Σ_{c} is an r by r matrix, and Vₑ⁻¹ is an r by l matrix. r is the rank of \tilde{h} as defined above. The smaller the rank r, the more dependencies exist between the channel estimates at the m network resources among the l samples and the more principal commonalities exist among the l samples.

ψ comprises the one or more eigenvectors as described above in respect of U. Each column of ψ may thus comprise one of the eigenvectors. Thus, for example, the matrix ψ may be expressed as ψ=[ψ₁, . . . , ψᵣ], in which each of the eigenvectors ψ_{1, . . . , r} has a length m. Since the rank of the \tilde{h} is often greater than one, ψ will typically comprise two or more eigenvectors. However, in general ψ may comprise one or more eigenvectors.

Σ_{c} is a diagonal matrix comprising the one or more non-zero singular values corresponding to the one or more eigenvectors. The diagonal matrix Σ_{c} may be expressed as
Σ_{c}=diag(σ)
   in which
σ=[σ₁, σ₂, . . . σᵣ]
   for non-zero singular values σ₁, σ₂, . . . σᵣ corresponding to eigenvectors [ψ₁, ψ₂, . . . , ψᵣ] comprised in the matrix ψ. The non-zero singular values may be ordered in the diagonal matrix Σ in decreasing size, such that σ₁>σ₂> . . . >σᵣ. σᵢ may indicate the degree of the importance of its associated eigenvector ψᵢ.

Therefore, the one or more eigenvectors [ψ₁, . . . , ψᵣ] may be obtained from a full-space SVD or a compact SVD of the first channel estimates. The compact SVD may be particularly advantageous since, when using the compact SVD, only the non-zero singular values and corresponding one or more eigenvectors are calculated (e.g., the singular values that are equal to zero are not calculated), which may save processing time and/or resources.

The rank of the joint channel estimate matrix \tilde{h} may be large, which means that an SVD (e.g., a full-space SVD or a compact SVD) may return a large number of eigenvectors and associated singular values. Rather than using all of the eigenvectors from the SVD (e.g., a full-space SVD or a compact SVD), a subset of a plurality of eigenvectors from the SVD may be used. Thus, the one or more eigenvectors may comprise a subset of a plurality of eigenvectors from an SVD of the first channel estimates.

In some examples, the one or more eigenvectors ψ may comprise a subset of the plurality of eigenvectors selected based on their associated singular values. Eigenvectors associated with larger singular values may represent the most typical commonalities or dependencies associated with the first configuration and same location. As such, eigenvectors associated with larger singular values may provide more relevant information than eigenvectors associated with smaller singular values. In some examples, the one or more eigenvectors ψ may comprise a subset of the plurality of eigenvectors which are associated with the largest (e.g., greatest) singular values. For example, N eigenvectors having the largest singular values may be kept, in which Nis a particular value. The one or more eigenvectors (e.g., those with the largest singular values) may be referred to as principal eigenvectors or kept eigenvectors.

Alternatively, the one or more eigenvectors may be obtained from a truncated SVD of the first channel estimates. For example, rather than performing a SVD (e.g., a full-space SVD or a compact SVD) and selecting the one or more eigenvectors as a subset of the eigenvectors returned by the SVD, a truncated SVD may be performed so that only t eigenvectors are returned by the SVD, in which t is a predetermined number.

Therefore, in some examples, the one or more eigenvectors may be obtained from a truncated SVD by decomposing the to the joint channel estimate matrix \tilde{h} in accordance with:

$$\tilde{h} \approx {ψ}_{t} {\sum }_{t} {V}_{t}^{- 1} ,$$

in which ψₜ is an m by t matrix, Σ_{c} is a t by t matrix, and Vₑ⁻¹ is a t by l matrix. t is a predetermined (e.g., configurable) number and t<r.

By obtaining the one or more eigenvectors from a truncated SVD, the processing time and/or resources used to determine the one or more eigenvectors may be further reduced.

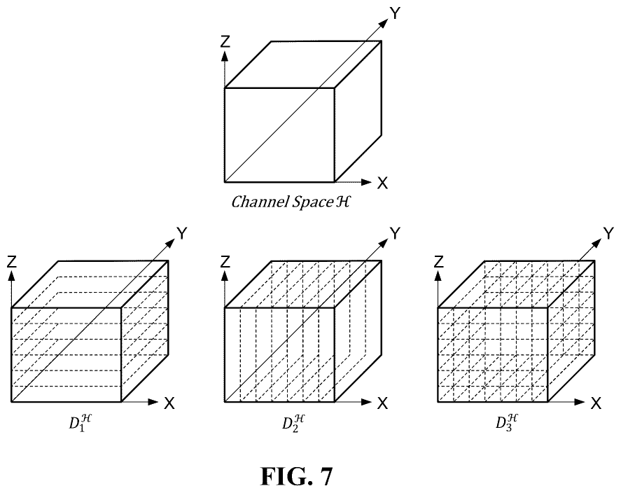

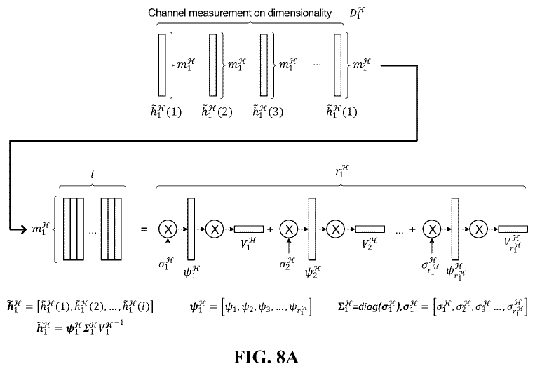

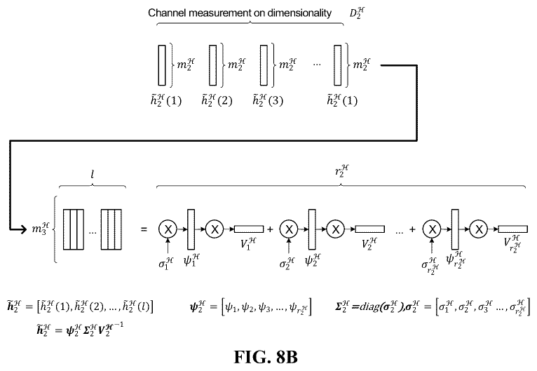

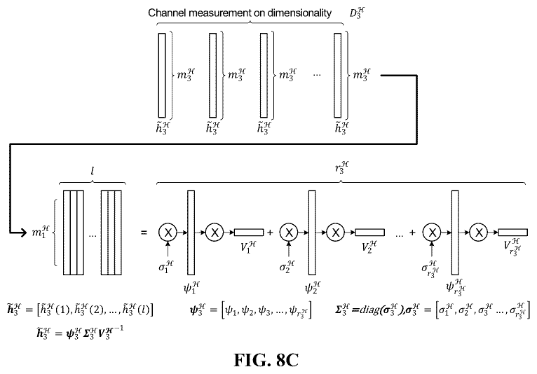

An example of using a compact SVD to obtain eigenvectors and singular values for three configurations is described with reference to FIGS. 7, 8A, 8B and 8C. FIG. 7 shows a channel [symbol] (e.g., a channel space) and three different configurations [symbol] , [symbol] and [symbol] for the channel [symbol] . The channel [symbol] has three dimensions, X, Y and Z. The dimensions may be, for example, any combination of time, frequency, code and space. In the first configuration [symbol] , the channel [symbol] is multiplexed along dimension Z and has degree of freedom [symbol] (e.g., the first configuration defines [symbol] network resources). In the second configuration [symbol] , the channel [symbol] is multiplexed along dimension X and has degree of freedom [symbol] (e.g., the first configuration defines [symbol] network resources). In the third configuration [symbol] , the channel [symbol] is multiplexed along dimensions X and Z and has degree of freedom [symbol] (e.g., the first configuration defines [symbol] network resources).

FIGS. 8A, 8B and 8C illustrate the determination of a respective one or more eigenvectors [symbol] and one or more singular values [symbol] for each of the three configurations from FIG. 7 using a compact SVD based on respective channel estimates [symbol] for the configurations i=1, 2, 3. The approach will be described with respect to the first configuration, shown in FIG. 8A, but a similar approach may be used for the configurations in FIG. 8B and FIG. 8C. As shown in FIG. 8A, the channel estimates for the first configuration [symbol] comprises l samples of channel measurements [symbol] (j) for j=1,2, . . . , l. Each sample has dimension [symbol] (e.g., corresponding to the number of network resources for the configuration).

The channel estimates for the first configuration are used to obtain, using a compact SVD, one or more first eigenvectors ψ₁ and respective singular values Σ₁=diag(σ₁) for first channel estimates [symbol] in accordance with

$$=$$

Each of the columns [symbol] =[ψ₁, ψ₂, ψ₃, . . . , [symbol] ] is a principal eigenvector representing a persistent dependency on the configuration ( [symbol] ). The total [symbol] eigenvectors for the first configuration are kept to represent the prior knowledge (e.g., in a prior structure) acquired from the l data samples.

The eigenvectors for the three configurations, [symbol] , [symbol] , [symbol] and the singular values σ₁, σ₂, σ₃ may be stored in a prior structure. More generally, a prior structure for a particular location g (e.g., a particular sub-region or grid in a cell) and N configurations (e.g., a plurality of configurations) may be formed from eigenvectors for the plurality of configurations according to:

[symbol] [symbol] , [symbol] [symbol] =f(g, [symbol] ), i=1,2, . . . N, In general, and as will be described in more detail below, one or more eigenvectors may be determined for a particular electronic device category c and one or more other parameters θ, such that the prior structure is formed from eigenvectors for the plurality of configurations for the particular location, g, category, c and parameters, θ, according to:

$$, = f ( g , c , , θ ) , i = 1 , 2 , … N$$

This prior structure may be function of the location (g, e.g., a grid), a user category (c), a configurations ( [symbol] ), and other parameters (θ) captures the [symbol] persistent dependencies [symbol] for the candidate configurations [symbol] .

In some embodiments, the TRP 502 may perform the SVD (e.g., a full-space, compact or truncated SVD). Thus, obtaining the one or more eigenvectors in step 510 may comprise obtaining the first channel estimates and inputting the first channel estimates to an SVD to determine the one or more eigenvectors (e.g., using any of the approaches for performing an SVD described above).

The TRP 502 may obtain the first channel estimates in any suitable way. The TRP 502 may receive the first channel estimates from an apparatus. For example, the TRP may be in a communications system and the TRP 502 may receive the channel estimates from an apparatus in a core network of the communications system (e.g., the core network 130 described above in respect of FIGS. 1-4). The TRP 502 may send the first configuration (e.g., obtained in step 508) and the location of the first electronic device 504 (e.g., obtained in step 506) to the apparatus and receive the first channel estimates in response.

In another example, the TRP 502 may collate the first channel estimates for the one or more second electronic devices. The TRP 502 may select the one or more second electronic devices based on the location and first configuration (e.g., as obtained in steps 506 and 508). The TRP 502 may thus select the one or more second electronic devices because they have the same location and configuration as the first apparatus 504. The one or more second electronic devices may comprise electronic devices (such as the electronic devices 110) that are or were connected to the TRP 502 and the TRP 504 may receive the first channel estimates from the one or more second electronic devices. In another example, the TRP 504 may determine the first channel estimates based on measurements (e.g., of reference signals) received from the one or more second electronic devices.

In other embodiments, the TRP 502 may receive the one or more eigenvectors from another apparatus. The SVD may be performed by another apparatus (e.g., performed elsewhere) and the other apparatus may transmit the one or more eigenvectors to the TRP 502. Obtaining the one or more eigenvectors in step 502 may comprise sending, to the other apparatus, the location of the first electronic device 504 and the first configuration and receiving, from the other apparatus, the one or more eigenvectors. Obtaining the one or more eigenvectors in step 502 may comprise sending, to the other apparatus, the first channel estimates (e.g., obtained using any of the approaches described above) and receiving, from the other apparatus, the one or more eigenvectors. In particular examples, the SVD may be performed by an apparatus in a core network (e.g., the core network 130 described above in respect of FIGS. 1-4) of a communications network comprising the TRP 502.

In some examples, step 510 may be performed before step 508. For example, the TRP 502 may determine the first configuration based on the one or more eigenvectors obtained in step 510. An example method for determining the first configuration is described below in respect of FIG. 9.

In step 512, the TRP 502 may send the one or more eigenvectors and an indication of the first configuration to the electronic device 504. The TRP 502 may send the one or more eigenvectors and the indication of the first configuration in one or more messages. For example, the TRP 502 may send the first configuration to the electronic device 504 in a first message and the one or more eigenvectors in a second message.

In step 514, the TRP 502 assigns one or more reference signals to one or more network resources selected from the plurality of network resources based on the one or more eigenvectors ψ=[ψ₁, ψ₂, . . . , ψᵣ].

Since the one or more reference signals are to be used for determining an estimate of the first channel between the TRP 502 and the electronic device 504, the distribution of the reference signals across the network resources may affect how adequately the channel can be sampled. However, the channel might not vary uniformly. For example, a channel may vary more in one part of the bandwidth than another. The variance between channel estimates may also depend on the configuration associated with the channel. For example, a channel may vary more in the time domain than in the frequency domain, but the variation in the time domain may be less apparent due to the configuration (e.g. if the network resources are defined to have a long duration).

Since the one or more eigenvectors may be indicative of the channel (e.g., any expected variance in the channel), the one or more eigenvectors may be used to assign reference signals according to the expected characteristics of the channel. This may be particularly advantageous since it allows for assigning reference signals non-uniformly. Thus, for example, according to the assignment of reference signals described herein, the density of reference signals may vary in different parts of the channel (e.g., at different frequencies and/or times). As such, the assignment of reference signals may be adapted according to variations across the channel. For example, this may lead to reference signals being assigned with a non-uniform density across the channel. This may allow for more representative channel estimates to be obtained whilst minimizing the number of reference signals used.

The number of reference signals to be assigned, p₁, may be a configured value. For example, one or both of the TRP 502 and the electronic device 504 may be configured to assign a particular number of reference signals. If only one of the TRP 502 and the electronic device 504 is configured with this value, it may indicate it to the other the TRP 502 and the electronic device 504 (e.g., as described below in respect of step 516).

Alternatively, the number of reference signals to be assigned may be based on the number of eigenvectors in the one or more eigenvectors. As discussed above, the number of eigenvectors obtained from the SVD may be equal to the rank r of the joint channel estimate matrix \tilde{h}. The rank r may be a measure of the dependencies between channel estimates that would be obtained at the m network resources, as indicated by the first channel estimates. Therefore, the rank r (and the number of eigenvectors) may also indicate a minimum number of reference signals for estimating the channel (e.g., a minimum number of reference signals needed to adequately estimate the channel). As such, the number of reference signals to be assigned may be set based the number of eigenvectors in the one or more eigenvectors. For example, the TRP 502 may determine to assign p₁ reference signals in which p₁ is equal to the number of eigenvectors (p₁=r). In another example, the number of eigenvectors may determine a minimum number of reference signals to be assigned (e.g., the TRP 502 may determine the number of reference signals to be greater than or equal to the number of eigenvectors).

Alternatively, the number of reference signals to be assigned may be based on the rank of the joint channel estimate matrix \tilde{h} (e.g., of the first channel estimates). This may be particularly appropriate when the one or more eigenvectors are obtained from a truncated SVD (e.g., the number of the one or more eigenvectors is less than the rank). Thus, the TRP 502 may obtain the rank of the joint channel estimate matrix \tilde{h} and set the number of reference signals to be assigned equal to, or greater than, the rank.

There are various ways in which the TRP 502 may assign the one or more reference signals to the one or more resources based on the one or more eigenvectors.

In an example, the TRP may assign the one or more reference signals by performing a search of the parameter space of possible assignments based on the one or more eigenvectors.

In another example, the assignment of the one or more reference signals may be based on a pivoted QR decomposition of the one or more eigenvectors ψ=[ψ₁, ψ₂, . . . , ψᵣ]. This may be particularly appropriate when the number of network resources, m, is large since it requires fewer computations than, for example, searching the parameter space of possible assignments.

In general, a pivoted QR decomposition can be used to decompose a matrix B into matrices Q, R and P according to
B=QRP^{T}
   or equivalently
BP=QR
   P may be referred to as the pivot or permutation matrix. Q is an orthonormal matrix and R is an upper triangular matrix.

When the channel exhibits a high sparsity with the configuration D, the pivot matrix P of the QR decomposition of ψ approximates (e.g., is asymptotically close to) an optimal assignment matrix Aₒₚₜ. In this context, an assignment matrix A indicates, for each of the plurality of network resources, whether or not a reference signal has been assigned to a particular resource. The assignment may also be referred to as placement, e.g. giving out the pₗ positions among the m network resource to be assigned to the reference signals. The optimal assignment matrix Aₒₚₜ may indicate the assignment which would yield the most representative or accurate channel estimates (e.g., for a particular number of reference signals), for example. As such, assigning the one or more reference signals to the one or more network resources based on a pivoted QR decomposition of ψ can approximate an optimal or best assignment scheme. This enables efficiently determining an assignment scheme that provides accurate and representative channel estimates.

Therefore, when the number of reference signals to be assigned is equal to the rank of ψ (e.g., p₁=r), the assignment matrix A may be determined according to
ψ^{T} A^{T}=QR,
   When p₁=r, this equation may be referred to as a determined equation. In contrast, when the number of reference signals to be assigned is less than the rank, the equation is underdetermined. When the number of reference signals to be assigned exceeds the rank of ψ (e.g., p₁>r), the placement matrix may be determined according to:
(ψψ^{T})A^{T}=QR.
   This may be referred to as the equation being overdetermined.

QR decomposition may yield an assignment matrix, A, which assigns more than the desired number of reference signals p₁. However, pivoted QR decomposition may be performed sequentially such that the most important reference signal placements are returned first. As a result, it may not be necessary to complete the QR decomposition process (e.g., to obtain the entire assignment matrix A) to assign the one or more reference signals. Instead, pivoted QR decomposition of the one or more of eigenvectors may be performed until the desired number of reference signal assignments has been obtained. Since the most important assignments are returned first, this can yield an effective assignment scheme using minimal processing.

Using a pivoted QR decomposition to assign the one or more reference signals may be particularly advantageous since a pivoted QR decomposition can be easily implemented using a householder process (e.g., algorithm) and a systolic-array architecture. It is numerically stable and tolerates fixed point data, which means it can be implemented without risk of floating point errors. It is fast and computationally inexpensive. In addition, sparse channels are expected to become increasingly common in next generation networks (e.g., 6^{th} generation or 6G networks), which means that QR decomposition may be particularly appropriate for assignment of reference signals in next generation (e.g. 6G) networks.

In step 516, the TRP 502 indicates the assignment of the one or more reference signals to the electronic device 504. The TRP 502 may, for example, send a message to the electronic device 504 identifying the one or more network resources that are to be used for the plurality of resources.

Alternatively, step 516 may be omitted and the first electronic device 506 may assign the one or more reference signals to the one or more network resources selected from the plurality of network resources based on the one or more eigenvectors ψ=[ψ₁, ψ₂, . . . , ψᵣ] in substantially the same manner as the TRP 502 described above in step 514. This may be particularly appropriate when the assignment process is deterministic such that the same assignment process can be performed at both the TRP 502 and the first electronic device 504 to yield the same result (such as the QR decomposition described above). Assigning the one or more reference signals at the electronic device 506 may provide the advantage of saving network resources (e.g., bandwidth) by eliminating the need to indicate the assignment of the one or more reference signals to the electronic device 506.

It may be particularly advantageous to assign the one or more reference signals using QR decomposition when assignment is performed at both the TRP 502 and electronic device 504, since this method is computationally inexpensive and thus may be implemented even if the electronic device 504 has limited processing resources.

In step 518, the TRP 502 transmits the one or more reference signals to the first electronic device 504 using the one or more network resources assigned in step 516. The reference signals may comprise any suitable reference signals such as, for example, a demodulation reference signal (DM RS), a cell-specific reference signal (CRS), a sounding reference signal, a ranging reference signal and/or a side-link reference signal etc. The TRP 502 may further transmit data to the first electronic device 504 in step 518. Thus, for example, the TRP 502 may transmit data one or more other network resources that are not assigned for reference signal transmission.

In step 520, the first electronic device 504 estimates the channel based 520 on measurements of the one or more reference signals to obtain a second channel estimate. The first electronic device 504 may be aware of which resources will be used for reference signals as it may have received the assignment in step 516. Alternatively, the first electronic device 504 may have independently calculated the assignment as described above.

Measurements of reference signals allow for sampling the channel at discrete intervals (e.g., at particular network resources). The estimate of the channel obtained by measuring reference signals assigned according to an assignment matrix A may be expressed in terms of the actual channel, h, according to:
ĥ=Ah.
   h may be referred to as the full-space (m) channel estimate (e.g., the estimate of the whole channel), whereas ĥ may be referred to as the subspace (pₗ) channel estimate or the one or more sampled channel estimates (e.g., the channel estimate on the one or more network resources assigned for reference signal transmission). The assignment matrix, A, indicates, for each of the plurality of network resources, whether or not a reference signal has been assigned to a particular resource. The assignment matrix may, for example, comprise 1 for a matrix element corresponding to a network resource that is to be used for transmission of a reference signal and 0 for a matrix element corresponding to a network resource that is not to be used for transmission of a reference signal.

Determining the second channel estimate may thus involve two steps: sampling the channel by measuring the one or more reference signals to obtain one or more sampled channel estimates, and determining the second channel estimate based on the one or more sampled channel estimates.

Measuring the one or more reference signals to obtain the one or more sampled channel estimates may comprise, for each of the one or more reference signals, determining a respective Least Square (LS) channel estimate ĥ(k) according to:

$$\hat{h} ( k ) = \frac{y ( k )}{c ( k )} , k = 1 , 2 , … {p}_{l}$$

in which y(k) is a measurement of a respective reference signal (e.g., the kth reference signal), c(k) is the corresponding transmitted reference signal (e.g., as transmitted by the TRP 502). c(k) is known to the first electronic device 504. For example, the first electronic device 504 may have been preconfigured with c(k).

In another example, measuring the one or more reference signals to obtain the one or more sampled channel estimates may comprise, for each of the one or more reference signals, determining a respective minimum mean square error channel estimate. In general, any suitable method may be used to obtain the one or more sampled channel estimated from measurements of the one or more reference signals.

In some examples, the electronic device 504 may determine the second channel estimate based on the one or more sampled channel estimates by estimating one or more coefficients based on the one or more sampled channel estimates, and determining the second channel estimate based on the one or more coefficients and the one or more eigenvectors.

This may be illustrated as follows. The channel (e.g., the full-space channel) can be expressed as a linear combination of the one or more eigenvectors and one or more coefficients according to:

$$h = {\sum }_{j = 1}^{{r}_{i}} {a}_{j} \cdot {ψ}_{j} = ψ a ,$$

in which α is a vector comprising one or more coefficients α=[α₁, α₂, . . . , αᵣ_{ᵢ}]. The one or more sampled channel estimates ĥ (e.g., the subspace or reference subspace channel estimates) may also be expressed as a linear combination of the one or more eigenvectors and one or more coefficients, further multiplied by the assignment matrix A:

$$\hat{h} = A ψ a . \qquad ( 1 )$$

Since the one or more sampled channel estimates, ĥ, can be estimated from the measurements of the reference signals, the one or more coefficients may be determined based on the one or more sampled channel estimates, the one or more eigenvectors ψ and the assignment matrix A according to the aforementioned relation.

For example, the one or more coefficients may be determined according to

$$a = {( A {ψ}_{opt} )}^{- 1} \hat{h} .$$

in which (A ψₒₚₜ)⁻¹ is the inverse or pseudo-inverse (e.g., Moore-Penrose inverse) of (A ψₒₚₜ). The inverse may be used in situations in which p₁=r. The pseudo inverse may be used in situations in which p₁>r.

Whilst this is provided as one way of determining the coefficients based on Equation (1), the skilled person will appreciate that there are many ways in which this equation may be solved. For example, Equation (1) may be solved using any of: an orthogonal matching pursuit (OMP) process, a mathematical programming (MP) process, a successive interference cancellation (SIC) process, a parallel interference cancellation (PIC) process and a turbo receiver.

The first electronic device 504 may determine the second channel estimate based on the one or more coefficients α and the one or more eigenvectors ψₒₚₜ according to:
h=ψₒₚₜα.

If the first electronic device 504 is satisfied with the second channel estimate, the electronic device 504 may indicate the second channel estimate to the TRP 502. The first electronic device 504 may, for example, attempt to use the channel estimate to decode data received from the TRP 502 and based on the decoding attempt, determine whether or not it is satisfied with the second channel estimate. For example, the first electronic device 504 may determine that the second channel estimate is not satisfactory responsive to failing to decode the data received from the TRP 502. In another example, the first electronic device 504 may determine that the second channel estimate is satisfactory responsive to decoding the data received from the TRP 502 (e.g., responsive to the decoded data passing a cyclic redundancy check). The first electronic device 504 may demodulate data received from the TRP 502 and based on a measurement of the noise error on the constellation, determine whether or not the second channel estimate is satisfactory. For example, the first electronic device 504 may determine that the second channel estimate is not satisfactory responsive to determining that the noise error exceeds a threshold value (e.g., when the noise error is big). In general, the first electronic device 504 may use any suitable criterion for determining whether the second channel estimate is satisfactory. The first electronic device 504 may thus, in response to determining that the second channel estimate satisfies a criterion, indicate the second channel estimate to the TRP 502.

In other examples, the first electronic device 504 may indicate the second channel estimate to the TRP 502 without performing any checks.

The first electronic device 504 may indicate the second channel estimate to the TRP 502 by sending the second channel estimate to the TRP 502. Alternatively, the first electronic device 504 may send the one or more coefficients α. Since the TRP 502 has the one or more eigenvectors ψ, the TRP 502 can calculate the second channel estimate based on the one or more coefficients and the one or more eigenvectors. In a further alternative, the electronic device 504 may send the sampled channel estimate to the TRP 502 (e.g., without calculating the one or more coefficients and/or the second channel estimate). The electronic device 504 may thus, for example, send the sampled channel estimate to the TRP 502 responsive to determining the sampled channel estimate is satisfactory (e.g., using the same or similar criteria described above in respect of the channel estimate). Alternatively, the electronic device 504 may send the sampled channel estimate to the TRP 502 without performing any checks.

In examples in which the electronic device 504 is unsatisfied with the channel estimate, the electronic device 504 may send a request to the TRP 502 for transmission of an increased number of reference signals. Thus, for example, the electronic device 504 may send the request responsive to determining that the channel estimate fails to satisfy a criterion (e.g., a criterion based on any of the checks described above). The electronic device 504 may thus request that the TRP transmits two or more further reference signals, in which the two or more further reference signals outnumber the one or more reference signals transmitted by the TRP 502 in step 518.

The request may indicate a specific number of reference signals to be transmitted. For example, the request may comprise a number of reference signals to be transmitted, p₂, in which p₂>p₁. In another example, the request may comprise an increment Δp=p₂−p₁ indicating the increase in the number of reference signals.

Responsive to receiving the request, the TRP 524 assigns, in step 524, two or more further reference signals to two or more network resources from the plurality of network resources. The TRP 524 may assign two or more further reference signals such that p₂ reference signals are assigned. The assignment of the two or more further reference signals may comprise the assignment of the one or more reference signals from step 514. Thus, the TRP 524 may add one or more additional reference signals to the existing assignment determined in step 514. For example, the TRP 524 may continue (e.g. resume) a pivoted QR decomposition that may have been started in step 514 and paused when p₁ reference signals were assigned. The TRP 524 may thus continue the pivoted QR decomposition until p₂ reference signals are assigned.

Alternatively, the TRP 524 may determine a new assignment for all of the two or more further reference signals. The assignment of the two or more further reference signals may be performed using any of the assignment methods described above in respect of step 514, for example.

In step 526, the TRP 502 indicates the assignment to the electronic device 504. In step 528, the TRP 502 transmits the two or more reference signals using the two or more network resources.

Step 526 and 528 may be carried out in substantially the same manner as steps 516 and 518 described above. In some examples, step 526 may be omitted and the electronic device 504 may assign the two or more further reference signals to two or more network resources from the plurality of network resources in the same manner as the TRP 502 in step 524. Thus, the TRP 502 and the electronic device 504 may independently determine the assignment.

If the electronic device 504 is unsatisfied with the channel estimate obtained in step 530, steps 522-530 may be repeated. For example, steps 522-530 may be repeated until the electronic device 504 is satisfied or until a maximum threshold number of iterations (e.g., repeats) is reached.

When the electronic device 504 is satisfied with the channel estimate obtained in step 530, the electronic device 504 may indicate the channel estimate to the TRP 502 in step 532. Step 532 may be carried out in substantially the same manner as the indication of the channel estimate described above.

The skilled person will appreciate that various modifications may be made to the aforementioned method 500. For example, the order of the steps may vary from that described above. Step 510, in which the one or more eigenvectors is obtained, may be performed before one or more of steps 504 and 506, for example. Step 512 may be performed after step 514, for example. Steps 512 and 516 may be combined such that, for example, the configuration and the assignment are transmitted in a single message. Step 506 may be omitted, for example.

Although the method 500 is described as being performed by the TRP 502 and the first electronic device 504, the skilled person will appreciate that in general the method may be performed by any suitable apparatus. Thus, the operations described as being performed by the TRP 502 may, in general, be performed by a first apparatus. The operations described as being performed by the electronic device 504 may, in general, be performed by a second apparatus.

Moreover, although the channel estimate information in the method 500 is described with reference to one or more second electronic devices, the first channel estimates may be for one or more apparatus (e.g., any suitable apparatus). In particular examples, the one or more apparatus may comprise a plurality of apparatus

In some examples, the one or more second electronic devices 504 may have a same category as the first electronic device 504. In this context, the category of the first electronic device 504 may indicate the capability of the first electronic device 504. For example, the category may comprise a user equipment (UE) category as defined for LTE networks. The first channel estimates, and thus the one or more eigenvectors, may thus be associated with the category of the first electronic device 504 and the second electronic devices. As such, the one or more eigenvectors may further capture dependencies of the first channel on the capability of the first electronic device.

The skilled person will appreciate that there are various other factors which may affect the first channel and/or estimate of the first channel. As such, in some examples, the second electronic devices may further share one or more parameters with the first electronic device 504. The second electronic devices may, for example, be grouped together based on their location, configuration, category and/or one or more other parameters. The first channel estimates, and thus the one or more eigenvectors, may be further be associated with a value of the one or more parameters for the first electronic device. The one or more parameters may relate to any factor which affects, or is likely to affect, the first channel and/or an estimate of the first channel.

Although the method 500 described above refers to one or more eigenvectors from an SVD of the first channel estimates, the skilled person will appreciate that, in other examples, other data characterizing the first channel estimates may be used instead of the one or more eigenvectors. Since the first channel estimates are indicative of the variations in the first channel for a first configuration and the location of the first electronic device 504, data from performing analysis on the first channel estimates may be used in place of the one or more eigenvectors. The analysis may, for example, extract characteristic data from the first channel estimates reflecting the variation of the channel across the plurality of network resource defined by the first configuration, for example. The analysis process may provide an output which is smaller than the first channel estimates (e.g. has a reduced dimensionality) whilst minimizing loss of relevant information. Any suitable analysis process may be used such as, for example, principal component analysis (PCA).

Alternatively, the first channel estimates themselves may be used in place of the one or more eigenvectors. Thus, for example, step 510 may be omitted, and the one or more reference signals may be assigned, in step 514, based on the first channel estimates directly.

As described above, a channel may be divided into a plurality of network resources by dividing the channel in one or more dimensions. In practice, a channel may vary differently across different dimensions. This may be referred to as a channel being more selective (e.g., variable) in some dimensions than others. For example, a frequency-time orthogonal frequency division multiplexing (OFDM) two-dimensional channel may exhibit more frequency-selectivity than time-selectivity. It may be advantageous to divide the channel into more network resources in less selective (less variable) dimensions and into fewer network resources in more selective (more variable) dimensions. Thus, in the example of the frequency-time OFDM two-dimensional channel, it may be advantageous to select a configuration with fewer sub-carriers but more OFDM symbols. However, exploring the parameter-space of possible configurations can be computationally expensive. It may involve, for example, repeatedly transmitting reference signals with different configurations to an apparatus to obtain channel estimates for the different configurations. This process may be referred to as sounding. The sounding procedure may incur a significant control overhead, particularly when the number of candidate configurations is large. This risks increasing energy consumption, occupying more bandwidth with control signals and increasing latency.

Aspects of the present disclosure provide a method for determining a configuration defining a plurality of first network resources for transmissions to a first apparatus based on channel estimate information. By using channel estimate information to determine a configuration, the configuration can be tailored to the channel whilst minimising control overhead.

FIG. 9 shows a flowchart of a method 900 according to embodiments of the disclosure. The method 900 is for determining a configuration defining a plurality of first network resources for transmissions to a first apparatus using a first channel. The method 900 may be used to determine the first configuration described above in respect of FIG. 5, for example. The first apparatus may be, for example, an electronic device such as the first electronic device 504 described above in respect of FIG. 5.

The method may be performed by a TRP, such as the TRP 502 described above in respect of FIG. 5, for example. In a further example, the method may be performed by a further apparatus in a core network of a communications network. For example, the communications network may comprise the first apparatus (e.g., connected to the network by a TRP) and the further apparatus in a core network of the communications network.

Step 902 comprises obtaining, for each of a plurality of configurations, a respective one or more eigenvectors ψ and one or more associated singular values σ (e.g., non-zero singular values). Each configuration may define a respective plurality of network resources in one or more dimensions (e.g., time, space, frequency etc.). The one or more eigenvectors and associated one or more singular values for a respective configuration are obtained from an SVD of a plurality of channel estimates for one or more respective second apparatus having the respective configuration. Thus, each of the configurations has an associated plurality of channel estimates. The second apparatus (e.g., for all of the configurations) have a same location (e.g., in which same location may be defined as above in respect of FIG. 5) as the first apparatus.

Obtaining the one or more eigenvectors ψ and associated singular values σ from the SVD for a particular configuration may comprise receiving the one or more eigenvectors ψ and associated singular values σ from, for example, another apparatus. Alternatively, obtaining the one or more eigenvectors ψ and associated singular values σ from the SVD may comprise perform the SVD to determine the one or more eigenvectors ψ and associated singular values σ (e.g., as described above in respect of FIG. 5).

In step 904, for each of the plurality of configurations, a respective rank and/or sparsity indicator for the respective configuration is obtained.

The rank, r, for a particular configuration may be the rank of a joint channel estimation matrix formed from the respective plurality of channel estimates for the particular configuration. The rank of a particular configuration may be the number of independent rows or columns of the respective joint channel estimation matrix, for example. The joint channel estimation matrix may be formed from the respective first channel estimates as described above in respect of FIG. 5, for example. The rank for a particular configuration may be the number of (e.g., the quantity of) the one or more eigenvectors for the configuration. Thus, the rank for a configuration Dᵢ associated with one or more eigenvectors ψᵢ=[ψ₁, ψ₂, . . . ψᵣ] may be equal to the number of columns of ψᵢ.

The sparsity of a particular configuration may indicate the extent to which the first dependencies dominate in the full-space. The sparsity of a particular configuration may indicate the variability of the channel across the network resources defined by the particular configuration. The sparsity indicator for a particular configuration may be based on the one or more singular values obtained for the configuration in step 902. In an example, the sparsity indicator for a configuration may comprise the strongest (e.g., largest) singular value in the subset of singular values. The singular values provided by the SVD may be ordered from the strongest singular value (e.g., largest) to the weakest (e.g., smallest). Thus, the sparsity indicator for one or more eigenvectors ψᵢ=[ψ₁, ψ₂, . . . ψᵣ] associated with a configuration Dᵢ may comprise the first singular value σ₁ in the associated one or more singular values σ=[σ₁, σ₂, . . . , σᵣ] obtained from the SVD. In another example, the sparsity indicator may comprise a ratio of the strongest (e.g., largest) singular value for the subset to the weakest (e.g., smallest non-zero) singular value for the particular configuration. Thus, the sparsity indicator may comprise a ratio of the first singular value for the configuration to the last singular value (e.g., last non-zero value) for the configuration. For example, the sparsity indicator may comprise σ₁/σᵣ, which may be referred to as the condition of ψᵢ.

In step 906, the configuration for the first channel of the first apparatus is determined based on the ranks and/or sparsity indicators determined in step 904. The configuration may be selected from the plurality of configurations based its associated rank and/or sparsity indicator.

The rank associated with a particular configuration may indicate the expected degree of dependency across the first channel at different network resources defined by the particular configuration. The smaller the rank, the greater the number of dependencies (e.g., the more indicative a channel estimate at a first network resource may be of the channel at a second network resource). Thus, in step 906, the subset of eigenvectors having the smallest rank may be selected. For example, if a first candidate configuration has a lower rank than a second candidate configuration, the first candidate configuration may be chosen.

The sparsity indicator provides a measure of the degree of dominance of the first eigenvector for a particular configuration. Therefore a smaller sparsity indicator may indicate that the first eigenvector for the configuration may be less dominant (e.g., compared to the other eigenvectors for the configuration). It may be advantageous to select a configuration having a more dominant first eigenvector, since a more dominant first eigenvector may more representatively capture variations (e.g., dependencies causing variations) in estimates of the channel at different network resources. Therefore, in step 906, the configuration having the highest sparsity indicator may be selected. For example, if a first candidate configuration has higher sparsity indicator than a second candidate configuration (e.g., a second candidate configuration having similar rank), the first candidate configuration may be selected.

The configuration may be selected based the rank and the sparsity. For example, step 906 may comprise selecting the configuration which minimizes both the rank and the sparsity indicator.

In an example, step 906 may comprise selecting the configuration, from the plurality of configurations, which minimizes a function of the rank and the sparsity indicator. For example, step 906 may comprise selecting the configuration which minimizes the function:

$$β \frac{{σ}_{1}}{{σ}_{r}} + ( 1 - β ) r ,$$

in which β ∈ [0,1] is a weighting which determines the relative importance of the sparsity indicator σ₁/σᵣ and r. The skilled person will appreciate that this is one example of a function of the rank and sparsity indicator and, in general, other functions may be used.

Therefore, according to the method 900, the configuration for a first apparatus may be determined based on channel estimates for a plurality of configurations. Each of the channel estimates are for a respective second apparatus having a same location, which means the channel estimates may account for local (e.g., environmental, such as geographical) factors that may affect the channel. Example factors may include reflective and/or fading radio paths affected by surrounding topology (e.g., high buildings, trees etc.). By using the channel estimates, any variations in the channel across different dimensions (e.g., time, frequency, space etc.) can be accounted for. Using an SVD allows for efficiently extracting and/or representing key dependencies from the channel estimates so that they may be used to inform the configuration selection. The present disclosure thus provides an efficient method for determining a configuration that is tailored to a particular channel. This can improve the reliability of transmissions on the channel, increase the number of available network resources and reduce control overhead.

The configuration may be further determined (e.g., selected) based on a preferred number of network resources. The first apparatus may, for example, indicate a criterion for the number of network resources. The criterion may define a particular number of network resources (e.g., a preferred number of network resources) or a threshold number of network resources (e.g., a minimum and/or maximum number of network resources). Since the configuration defines the network resources for transmissions to a first apparatus using the first channel, the configuration defines the number of network resources for the first apparatus. In order to determine a configuration satisfying the criterion, each of the plurality of configurations referred to in step 902 may define a number of network resources which satisfies the criterion. Thus, for example, each of the plurality of configurations referred to step 902 may define at least X network resources, in which X is a minimum number of network resources (e.g., specified by the first apparatus).

In some examples, the configuration may be further based on a category of the first apparatus, in which the category is defined as described above in respect of FIG. 5. For example, the second apparatus referred to in step 902 and the first apparatus may have the same category. Thus, the channel estimates used to determine the eigenvectors and the associated singular values may be for second apparatus having the same category as the first apparatus. As such, the eigenvectors and associated singular values determined in step 902 may be associated with (e.g., specific to) the category of the first apparatus (e.g., in addition to being specific to the location of the first apparatus).

The present disclosure thus provides a method 900 for determining a configuration defining a plurality of first network resources for transmissions to a first apparatus using a first channel. The method 900 may be used to obtain the first configuration in step 508 described above in respect of FIG. 5 (noting that the method described in respect of FIG. 5 may be adapted such that step 508 may be performed after step 510).

### Prior Structures and Reference Signal Placement Scheme

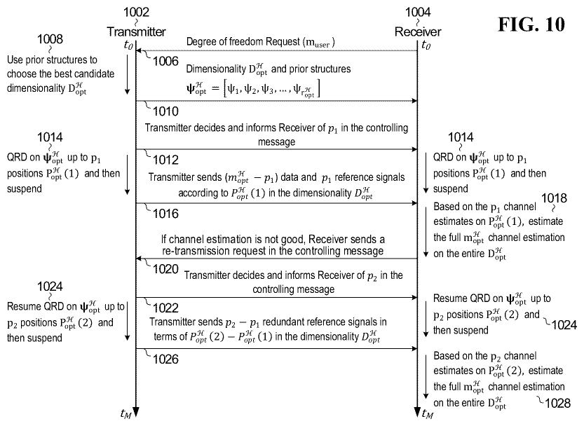

FIG. 10 shows a signalling diagram of a method according to embodiments of the disclosure. The method may be an example implementation of the method 500 described above in respect of FIG. 5. The method may begin at time tₒ and end at time t_{M}, for example.

The method may begin in step 1006 with a transmitter 1002 receiving from a receiver 1004, a request 1006 for a dimensionality for transmissions between the receiver 1004 and the transmitter 1002. The transmitter may be a TRP, such as the TRP 502 described above in respect of FIG. 5. The receiver may an electronic device, such as the electronic device 504 described above in respect of FIG. 5.

The dimensionality may be defined in the same manner as the first configuration described above in respect of FIG. 5. The dimensionality may define a plurality of network resources for transmissions between the receiver 1004 and the transmitter 1002. In this example, the request indicates a degree of freedom for the dimensionality mᵤₛₑᵣ (e.g., the number of network resources to be defined by the dimensionality).

In step 1008, the transmitter 1002 determines a dimensionality (or, interchangeably, transmission configuration) for transmissions between the receiver 1004 and the transmitter 1002 based on prior structures for the channel between the transmitter 1002 and the receiver 1004. The prior structures comprise a plurality of eigenvectors. The plurality of eigenvectors may comprise, for each of a plurality of respective dimensionalities (e.g., configurations), one or more respective eigenvectors. Each set of one or more eigenvectors is associated with a particular dimensionality (or configuration). The transmitter 1002 may determine the dimensionality in accordance with the method 900 described above in respect of FIG. 9. Thus, for example, the prior structures may be obtained in accordance with step 902 described above. The dimensionality may be selected from the plurality of dimensionalities in accordance with the selection of the configuration from the plurality of configurations in step 906 described above. The selected dimensionality may be referred to as the best candidate dimensionality, [symbol] , or the chosen dimensionality, for example. The dimensionality is associated with one or more eigenvectors (also referred to as a prior structure), [symbol] =[ψ₁, ψ₂, ψ₃, . . . [symbol] ], in which [symbol] is the rank of the one or more eigenvectors.

In step 1010, the transmitter 1002 sends the dimensionality [symbol] and one or more eigenvectors [symbol] =[ψ₁, ψ₂, ψ₃, . . . , [symbol] ] to the receiver 1004.

In step 1012, the transmitter 1002 indicates, to the receiver 1004, a number of reference signals to be assigned p₁. p₁ may thus be the quantity of network resources that are to be used for transmitting reference signals to the receiver 1004. In general, the number of reference signals to be assigned is no less than the rank of the one or more eigenvectors, e.g., P₁≥ [symbol] . The transmitter 1002 may send the indication in a control message. For example, the transmitter 1002 may, in step 1012, send a control message to the receiver including the number of reference signals to be assigned p₁.

In step 1014, the transmitter 1002 and the receiver 1004 use a pivoted QR decomposition (QRD) of the prior structures (e.g., the one or more eigenvectors) to determine a first assignment matrix [symbol] (1) which indicates the assignment (placement) of p₁ reference signals to network resources defined by the dimensionality [symbol] . The QR decomposition may be performed on

$$\cdot {T}^{}$$

in case of overdetermined (p₁> [symbol] ). The assignment matrix may correspond to the assignment matrix described above in respect of FIG. 5. The transmitter 1002 and the receiver 1004 may thus independently perform respective pivoted QR decompositions of the prior structures in step 1014. Step 1014 may be performed in the same manner as the pivoted QR decomposition described above in respect of step 514 in FIG. 5. Thus, for example, the transmitter 1002 and the receiver 1004 may perform their respective pivoted QR decompositions until the first p₁ reference signal positions. Once the first p₁ reference signal positions are determined, the respective pivoted QR decomposition may be suspended. The excellent numeric stability of QR decomposition may guarantee that the transmitter 1002 and the receiver 1004 find the exactly same [symbol] (1).

In step 1016, the transmitter 1002 transmits p₁ reference signals to the receiver 1004 on the channel [symbol] . The transmitter 1002 transmits the p₁ reference signals on the positions according to the assignment (placement) matrix [symbol] (1). Since the transmission dimensionality [symbol] defines [symbol] network resources, this leaves ( [symbol] −p₁) unassigned (e.g., available for use). Thus, the transmitter 1002 may transmit data on some or all of ( [symbol] −p₁) network resources that are not assigned for reference signals. Thus, step 1016 may comprise the transmitter 1002 transmitting data on ( [symbol] −p₁) network resources and reference signals on p₁ network resources in accordance with the assignment (placement) matrix [symbol] (1).

The receiver 1004 receives the p₁ reference signals and any data transmitted in step 1016. In step 1018, the receiver 1004 performs measurements on the p₁ reference signals. For example, the receiver 1004 may performs measurements on the p₁ reference signals to determine a sampled channel estimate ĥ (a subspace channel estimate), which may be used to determine a channel estimate (e.g., a full-space channel estimate). Step 1018 may be performed in accordance with step 520 described above in respect of FIG. 5, for example.

If the receiver 1004 has no confidence to recover the channel estimate across the entire dimensionality (e.g., the receiver 1002 is not confident that the full-space channel can be adequately estimated based on the sampled channel estimates), the receiver 1004 requests, in step 1020, transmission of additional reference signals by the transmitter 1002. Step 1020 may comprise the receiver 1002 sending a control message (e.g., an uplink control message) to the transmitter 1004 to ask for more reference signals. Step 1020 may be performed in accordance with step 522 described above in respect of FIG. 5, for example.

In step 1022, the transmitter 1002 indicates a number of reference signals to be assigned p₂, in which p₂>p₁. The transmitter 1002 may determine the quantity of reference signals to be assigned p₂ and, in step 1022, send p₂ to the receiver 1004. The transmitter 1002 may indicate p₂ to the receiver 1004 in a control message (e.g., in a downlink control message). In other examples, the receiver 1004 may indicate p₂ to the transmitter 1002 in step 1020 and thus step 1022 may be omitted.

In step 1026, the transmitter 1002 and the receiver 1004 resume the same pivoted QR decomposition that was suspended in step 1014. The pivoted QR decomposition is continue until the first p₂ reference signal positions are found. The excellent numeric stability of QR decomposition guarantees that both find the same assignment matrix [symbol] (2). In addition, the nature of QR decomposition ensures [symbol] (1) ∈ [symbol] (2).

In step 1026, the transmitter 1002 transmits p₂−p₁ reference signals on p₂−p₁ network resources whose positions are in accordance with [symbol] (2)− [symbol] (1) of the channel [symbol] with the transmission dimensionality [symbol] . The transmitter 1002 may transmit data on the remaining ( [symbol] −(p₂−p₁) network resources (e.g., network resources not occupied by reference signals).

The receiver 1004 receives the reference signals on the p₂−p₁ network resources indicated by [symbol] (2)− [symbol] (1) of the channel [symbol] with the transmission dimensionality [symbol] . Thus, in steps 1016 and 1026 the receiver 1026 receives a total of p₂ reference signals from the transmitter 1002 as indicated by [symbol] (2).

In step 1028, the receiver 1004 uses measurements of the p₂ reference signals received from the transmitter 1002 to determined sampled channel estimates (subspace channel estimates). The sampled channel estimates comprise estimates of the channel at each of the network resources over which reference signals were transmitted. The receiver 1004 may use the sampled channel estimate to determine a channel estimate (e.g., a full-space channel estimate). Step 1028 may be performed in accordance with step 530 described above in respect of FIG. 5, for example.

The method described in respect of FIG. 10 may allow for determining a reference signal placement scheme for a channel that is adapted to the transmission dimensionality (e.g., configuration) of the channel. In the method, a reference signal placement scheme can be computed deterministically from the prior structure [symbol] . Since both the transmitter 1002 and receiver 1004 know the same [symbol] , both can derive exactly same placement scheme [symbol] from [symbol] . Moreover, the computation of the placement scheme is computationally efficient enough that it can be performed at the receiver, even if it has limited processing resources. In particular examples, this may yield a non-uniform reference signal placement scheme. A non-uniform placement scheme may place reference signals more densely on more distorted or selective subspace (e.g., more distorted or variable parts of the channel) and less densely on less distorted or selective subspace of a chosen dimensionality [symbol] .

### Prior Structures for Channel Estimation

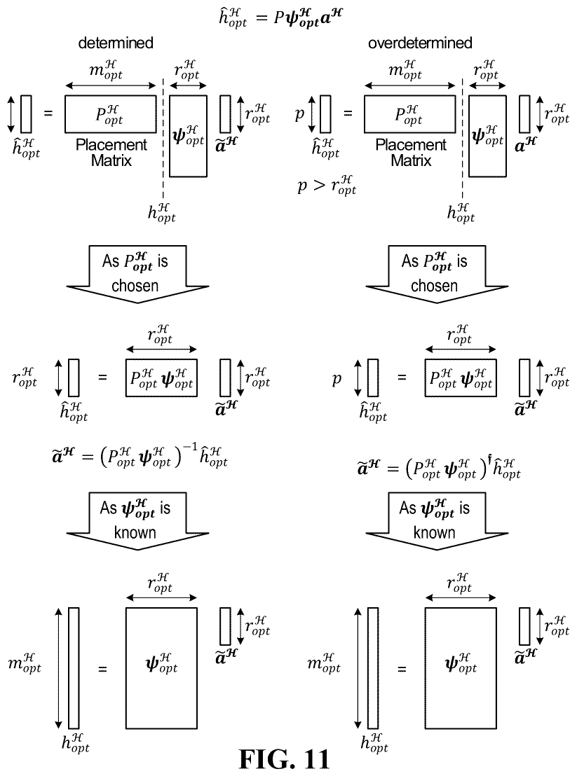

FIG. 11 shows two methods for determining a channel estimate, [symbol] , based on sampled channel estimates [symbol] obtained from measurements of p reference signals transmitted from the transmitter 1002 to the receiver 1004. The methods may be performed in accordance with step 520 described above in respect of FIG. 5, for example. The p reference signals are transmitted according to an assignment matrix [symbol] (also referred to as a placement matrix) for the transmission dimensionality [symbol] which defines [symbol] network resources. The transmission dimensionality [symbol] is associated with one or more eigenvectors [symbol] defined as above in respect of FIG. 10.

The p reference signals may be transmitted in accordance with step 1016, for example. Thus, for example p=p, and [symbol] = [symbol] (1). The p reference signals may be transmitted in accordance with step 1026, for example. Thus, for example p=p₂ and [symbol] = [symbol] (2).

In both methods, the sampled channel estimates may be used to determine one or more coefficients [symbol] which may be used to determine the channel estimate [symbol] (e.g., the full-space channel estimate). In general, the one or more coefficients [symbol] include [symbol] coefficients in which [symbol] is the rank of the one or more eigenvectors. The one or more coefficients are related to the sample channel estimates, the one or more eigenvectors and the assignment matrix according to

[symbol]

When the number of reference signals, p, is equal to the rank [symbol] of the one or more eigenvectors for the dimensionality of the channel [symbol] (e.g., p= [symbol] )this equation is said to be determined. The method for determining the channel estimate in this scenario is illustrated on the left half of FIG.11 (“determined”). When the number of reference signals, p, exceeds the rank [symbol] of the one or more eigenvectors for the dimensionality of the channel [symbol] (e.g., p> [symbol] ), this equation is said to be overdetermined. The method for determining the channel estimate in this scenario is illustrate on the right half of FIG. 11 (“overdetermined”).

In the determined scenario (when p= [symbol] ), the one or more coefficients may be estimated based on the sampled channel estimates and the one or more eigenvectors according to:

$$= {( )}^{- 1} ,$$

in which [symbol] is an estimate of [symbol] . In the overdetermined scenario (when p> [symbol] ), the one or more coefficients may be estimated based on the sampled channel estimates and the one or more eigenvectors according

$$= {( )}^{f} ,$$

in which ( [symbol] )^{f} is the pseudo inverse (or Moore-Penrose inverse) of ( [symbol] ). As [symbol] is a p-by- [symbol] matrix, the computation complexity and cost to solve the equation may be on the order of p and [symbol] rather than [symbol] , in which [symbol] <p << [symbol] .

In practice, various implementations may be used to solve the equation [symbol] =( [symbol] ) [symbol] to obtain the estimated coefficients [symbol] . In some examples, one or more of: an orthogonal matching pursuit (OMP) process, a mathematical programming (MP) process, a successive interference cancellation (SIC) process, a parallel interference cancellation (PIC) process and a turbo receiver may be used to determine the estimated coefficients.

The channel estimate [symbol] may be determined based on the one or more estimated coefficients and the one or more eigenvectors according to:
[symbol] =ψₒₚₜ [symbol] .

### Signalling for Channel Estimation

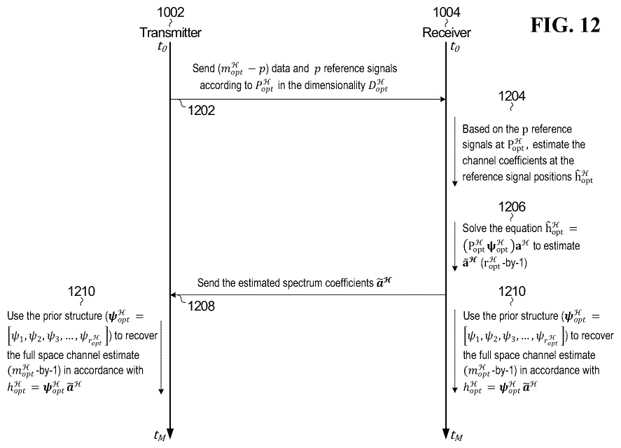

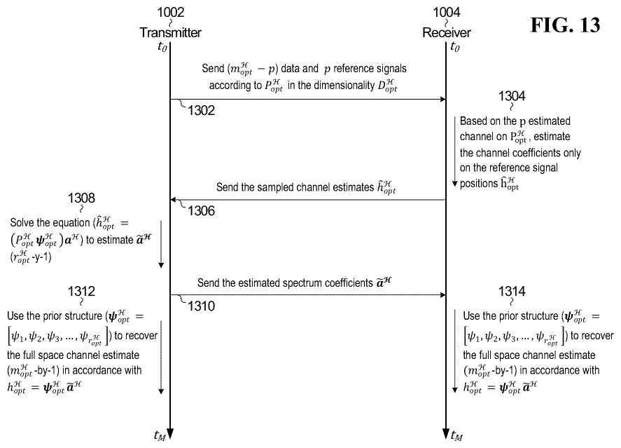

The aforementioned methods for determining the channel estimate may be performed by the transmitter 1002, the receiver 1004 or distributed across the transmitter 1002 and the receiver 1004 (e.g., such that some steps are performed at the transmitter 1002 and other steps are performed at the receiver 1004). This may be illustrated by the examples shown in FIGS. 12 and 13, which show signalling for respective methods of determining a channel estimate for the channel between the transmitter 1002 and the receiver 1004 according to embodiments of the disclosure.

The method illustrated in FIG. 12 begins in step 1202 in which the transmitter 1202 transmits, to the receiver, the p reference signals in accordance with the assignment matrix [symbol] for the dimensionality [symbol] . Step 1202 may be performed in accordance with step 1016 described above in respect of FIG. 10, for example. Thus, for example [symbol] = [symbol] (1). In another example, step 1202 may be performed in accordance with step 1026 described above in respect of FIG. 10, for example. Thus, for example [symbol] = [symbol] (2).

In step 1204, the receiver 1004 performs measurements on the p received signals to obtain sampled channel estimates [symbol] . The sampled channel estimates [symbol] include estimates of the channel at the positions of the p reference signals (e.g., at the network resources over which the p reference signals are transmitted in step 1202). The sampled channel estimates [symbol] effectively sample the channel on the subspace defined by the assignment matrix [symbol] . The sampled channel estimates may be referred to as the subspace estimates or the subspace channel estimates. The sampled channel estimates may have dimension p by 1.

In step 1206, the receiver 1004 uses the sampled channel estimates to estimate the coefficients according to [symbol] =( [symbol] ) [symbol] . The receiver 1004 may, for example, estimate the coefficients using any of the methods described above in respect of FIG. 11. The estimated coefficients [symbol] form a matrix with dimensions [symbol] by 1.

In step 1208, the receiver 1004 sends the estimated coefficients (also referred to as the spectrum coefficients) to the transmitter 1002. The receiver 1004 may send the estimated coefficients in a control message (e.g., an uplink control message).

In step 1210, one or more of the receiver 1004 and the transmitter 1002 determine channel estimate [symbol] based on the estimated coefficients [symbol] and the one or more eigenvectors (e.g., the prior structures). Thus, the transmitter 1002 and/or the receiver 1004 may use the prior structure [symbol] =[ψ₁, ψ₂, ψ₃, . . . , [symbol] ] to recover the channel estimation on the full space [symbol] -by-1 (e.g., to recover the full-space channel estimate [symbol] ). The channel estimate may be determined as described above in respect of FIG. 11, for example.

According to the method shown in FIG. 12, the receiver 1004 may transmit only the the [symbol] estimated spectrum coefficients [symbol] to the transmitter 1004, because the transmitter 1002 can recover [symbol] from [symbol] with [symbol] . This reduces the network resources needed to indicate the channel estimate to the transmitter 1004.

FIG. 13 shows an alternative method to the method described above in respect of FIG. 12.

Steps 1302 and 1304 of the method correspond to steps 1202 and 1204 described above.

In step 1306, the receiver 1004 sends the sampled channel estimates [symbol] to the transmitter 1002. The receiver 1004 may send the sampled channel estimates [symbol] to the transmitter 1002 in a control message (e.g., an uplink control message).

In step 1308, the transmitter 1002 uses the sampled channel estimates to estimate the coefficients according to [symbol] =( [symbol] ) [symbol] . Step 1308 may be performed in substantially the same manner as step 1206, except that it is performed at the transmitter 1002 rather than the receiver 1004.

In step 1310, the transmitter 1002 sends the estimated coefficients [symbol] to the receiver 1004. The transmitter 1002 may send the estimated coefficients [symbol] to the receiver 1004 in a control message, such as a downlink control message.

In step 1312, one or more of the receiver 1004 and the transmitter 1002 determine channel estimate [symbol] based on the estimated coefficients [symbol] and the one or more eigenvectors (e.g., the prior structures). Step 1312 may be performed in accordance with step 1210.

In the method shown in FIG. 13, determination of the coefficients is performed at the transmitter 1002, which reduces the computation performed at the receiver 1004. This may be particularly advantageous for low-end (e.g., less capable) or low-power receivers. This also uses fewer network resources than calculating the full-space channel estimate at the receiver 1004 since [symbol] <p<< [symbol] , which means that transmitting [symbol] and [symbol] consumes fewer network resources (e.g., requires a smaller radio bandwidth) than transmitting

[symbol]

### Multiple Access

Multiple access techniques are widely used to improve bandwidth efficiency by allocating multiple users along one or more orthogonal dimensions of a common dimensional channel. Multiple-access techniques may be used to divide a channel [symbol] into two channels [symbol] ∈ [symbol] and [symbol] ∈ [symbol] , in which ( [symbol] ∪ [symbol] ) ∈ [symbol] . If [symbol] and [symbol] are non-overlapping ( [symbol] ∩ [symbol] =ϕ), this described as orthogonal multiple access (OMA). If [symbol] and [symbol] are at least partially overlapping to each other ( [symbol] ∩ [symbol] ≠99 ), this is non-orthogonal multiple access (NOMA). Advanced signal processing processes (e.g., algorithms) are usually employed at NOMA receivers to eliminate the overlapping part. This overlapping part may be referred to as multiple-access interference (MAI).

There are two typical methods used to share the channel in multiple access techniques. One method is referred to as sub-dimensional division. In sub-dimensional division a common dimensional channel may be divided along one or several transmission dimensions. This division may be standardized (e.g., the same division may be used for multiple transmitter-receiver pairs). For example, in frequency division multiple access (FDMA), the channel may be divided along the frequency dimension. In time division multiple access (TDMA), the channel may be divided along the time dimension. In code division multiple access (CDMA), the channel may be divided along the coding dimension.

However, sub-dimensional division methods can face challenges due to non-uniform distortion distribution across all dimensions of the channel [symbol] , which can cause differences between channel measurements from one transmission dimensionality [symbol] to another [symbol] . The distortions and differences may vary from one location to another (e.g., between cells or within a cell). Standardized division along one or several transmission dimension may not fit the realistic dimensional channel [symbol] , which risks increasing multiple access interference.

The other method is referred to as full-dimensional pairing. In full-dimensional pairing, the channels of multiple apparatus (e.g., multiple electronic devices connected to a network device such as a TRP) may be monitored. The network may try to group (e.g., pair) electronic devices that share a transmission dimensionality (e.g., a configuration) and exhibit some orthogonality in a common channel [symbol] . One example of this is multiple user MIMO user pairing.

However, pairing or grouping apparatus for full-dimensional pairing can be time consuming and computationally expensive, which risks causes high latency. For each potential pairing, a network device (e.g., a TRP) might measure multiple access interference between or among multiple apparatus (e.g., multiple electronic devices). When there are a large number of apparatus, it can become computationally forbidden (e.g., prohibitively expensive in terms of processing power and/or time).

The present disclosure further provides a method for allocating parts of a channel to two or more apparatus.

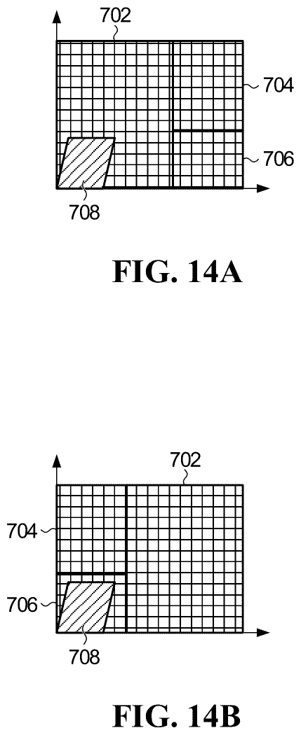

FIG. 14A shows a plurality of network resources multiplexed for a channel. The plurality of network resources are divided into three allocations: a first allocation 1402 for a first apparatus, a second allocation 1404 for a second apparatus and a third allocation 1406 for a third apparatus. Each allocation comprises a respective subset of the plurality of network resources.

The plurality of network resources encompass a region 1408 of the channel which is more highly varying (e.g., experiences more and/or greater fluctuations) than the rest of the channel spanned by the network resources. In another words, the region 1408 may have a pattern (e.g., a channel) which is very different from the rest. According to the allocations shown in FIG. 14A, the first allocation 1402 for the third apparatus includes this highly-varying region, as well as other parts of the channel that are not highly varying.

However, in some methods for assigning reference signals to network resources, reference signals may be uniformly distributed with a density depending on the variability of the channel. This means that the density of reference signals across the entire third allocation may be affected by the variability of the channel in the highly varying region. Thus, in the example shown in FIG. 14A, an excess of reference signals may be assigned to parts of the first allocation 1402 which are not highly varying.

FIG. 14B shows alternative allocations for the plurality of network resources for the channel. The plurality of network resources are again divided into three allocations: a first allocation 1402 for a first apparatus, a second allocation 1404 for a second apparatus and a third allocation 1406 for a third apparatus. However, according to this allocation scheme, the highly varying region 1408 occupies the majority of the third allocation 1406. This reduces the risk of an excess of reference signals being assigned to parts of the channel (e.g., one or more frequency ranges and/or one or more time periods) which are not highly varying, which can make additional network resources available for data transmission. This demonstrates that allocating parts of the channel to the first, second and third apparatus based on the characteristics of the channel can improve resource usage efficiency.

According to the present disclosure, a method of allocating parts of a channel to a first apparatus and a second apparatus is provided. This may be referred to as sub-dimensional division, for example. This may be applied in the context of orthogonal multiple access (OMA) or non-orthogonal multiple access (NOMA), for example. The first and second apparatus are in a same location (e.g., same location may be as defined above in respect of FIG. 5). Thus, the first and second apparatus may be in a same cell or same sub-region of a cell, for example.

The method comprises obtaining a plurality of allocation schemes for a channel, in which each allocation scheme comprises a first allocation of a first part of the channel to the first apparatus, and a second allocation of a second part of the channel to the second apparatus. Thus, for example, the first allocation may allocate a first frequency range of the channel to the first apparatus and the second allocation may allocate a second frequency range of the channel to the second apparatus. In another example, the first allocation may allocate a particular time period (e.g., one or more symbols) to the first apparatus and the second allocation may allocate another time period (e.g., one or more other symbols) to the second apparatus. Each allocation may specify one or more network resources to be used by the respective apparatus (e.g., for transmissions by the respective apparatus). The one or more network resources may be defined in one or more dimensions (e.g., time, frequency, space and/or code).

Obtaining the plurality of allocation schemes may comprise determining the plurality of allocation schemes. For example, for each of the plurality of allocation schemes, the first and second parts of the channel may be determined according to one or more rules. For example, in one allocation scheme, for a channel having a frequency range from X to Y, the first half of the bandwidth (e.g., the lower half of the frequency range) may be allocated to the first apparatus and the second half of the bandwidth (e.g., the upper half of the frequency range) may be allocated to the second apparatus. Any suitable process may be used for determining the plurality of allocation schemes.

Alternatively, obtaining the plurality of allocation schemes may comprise receiving the plurality of allocation schemes (e.g., from another apparatus).

The method further comprises determining, for each of the plurality of allocation schemes, a first configuration defining a first plurality of network resources for the first part of the channel and a second configuration defining a second plurality of network resources for the second part of the channel. The first configurations and the second configurations are determined using the method 900 described above in respect of FIG. 9.

The method further comprises, for each allocation scheme, computing a respective score based on the respective ranks r^{D}^{₁}, r^{D}^{₂} and sparsity indicators [symbol] , for the first configuration D₁ and the second configuration D₂. The score for a particular allocation scheme may be computed according to

$${\sum }_{j = 1}^{2} ( {β}^{{D}_{j}} \frac{{σ}_{1}^{{D}_{j}}}{{σ}_{{r}^{{D}_{j}}}^{{D}_{j}}} + ( 1 - {β}^{{D}_{j}} ) {r}^{{D}_{j}} )$$

in which β^{D}^{ⱼ} is a weighting which may be configured to determine a relative importance of the rank and the sparsity indicator.

The method further comprises selecting the allocation scheme based on the scores. For example, the allocation scheme with the smallest score may be selected.

The respective ranks and sparsity indicators are indicative of the characteristics channel. Therefore, selecting the allocation scheme based on scores computed from the ranks and sparsity indicators allows for adaptively allocating parts of the channel to the first apparatus and the second apparatus based on the channel characteristics. This can reduce multiple access interference (MAI).

Although the aforementioned method was described in respect of allocating parts of the channel to a first apparatus and a second apparatus, the skilled person will appreciate that, in general, the method may be used to allocate parts of the channel to two or more apparatus. The two or more apparatus may be any suitable apparatus such as, for example, electronic devices (e.g., any of the electronic devices 110 described above in respect of FIGS. 1-4 or the electronic device 504 described above in respect of FIG. 5).

In another aspect, a method of allocating a channel to two or more apparatus is provided. This may be referred to as full-dimensional pairing. The two or more apparatus to which the channel (or part of the channel) is allocated may share the channel (or part of the channel), for example. This may be applied in the context of orthogonal multiple access (OMA) or non-orthogonal multiple access (NOMA), for example. The method may be performed by a TRP, such as any of the TRPs 170, 172 described above in respect of FIGS. 1-4 or the TRP 502 described above in respect of FIG. 5.

The two or more apparatus are in a same location (e.g., same location may be as defined above in respect of FIG. 5). Thus, the two or more apparatus may be in a same cell or same sub-region of a cell, for example. Each of the two or more apparatus have a same configuration, in which the configuration is defined in the same manner as in the description of FIG. 5.

The method comprises, for each of the two or more apparatus, obtaining a respective one or more coefficients. The one or more coefficients correspond to the one or more coefficients described in step 520 of the method described in respect of FIG. 5 above. Thus, for example, steps 506-520 of the method described above in respect of FIG. 5 may be performed for each of the two or more apparatus in order for the respective one or more coefficients to be determined.

The coefficients for the two or more apparatus may be obtained by receiving, for each of the two or more apparatus, the respective one or more coefficients from the respective apparatus.

Since the two or more apparatus are in the same location and have the same configuration, they are associated with the same one or more eigenvectors. That is, coefficients of the two or more apparatus all share a same basis (e.g., are in the same vector space).

The method further comprises grouping the two or more apparatus into one or more groups based on their respective coefficients. This may be illustrated by considering an example in which the two or more apparatus comprise a first apparatus and a second apparatus.

In this example, the first apparatus has two strong coefficients α₁ and α₂ (e.g., a₁ and a₂ may be above a threshold value), but very weak coefficients α₃ and α₄ (e.g., α₃, α₄Δ0). The second apparatus has two strong coefficients α₃ and α₄, but very weak coefficients α₁ and α₂ (e.g., α₁, α₂→0). Since the two apparatus have different strong coefficients, there is orthogonality between the first apparatus and the second apparatus which may be used to share the channel between the first apparatus and the second apparatus (e.g., using Multiple User MIMO).

The method may thus further comprise grouping the two or more apparatus into one or more groups based on their respective one or more coefficients. For example, apparatus having different strong coefficients and/or different weak coefficients (e.g., indicating orthogonality) may be grouped in a same group. The one or more groups may be used for MU-MIMO, for example. For example, apparatus in a same group may be scheduled transmissions at a same time or overlapping times according to MU-MIMO.

By grouping the two or more apparatus into one or more groups based on their respective coefficients, aspects of the present disclosure provide a more efficient method for grouping apparatus which demonstrate at least some orthogonality in a common channel. By grouping apparatus which demonstrate at least some orthogonality in a common channel, a channel can be shared by multiple apparatus whilst reducing multiple-access interference. This may be particularly advantageous when the number of apparatus is large, since it can mitigate the need to measure multiple-access interference for each group of users and thus reduce computational processing.

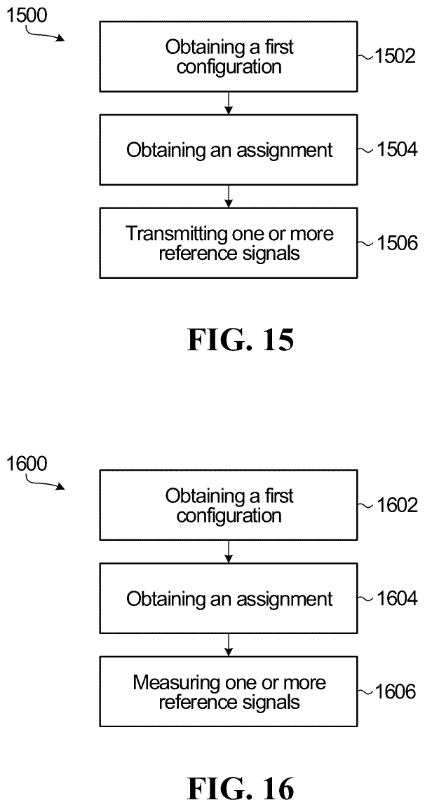

FIG. 15 shows a flowchart of a method 1500 according to embodiments of the disclosure. The method may be performed by any suitable apparatus. The method 1500 may be performed by a TRP, such as the TRP 502 described above in respect of FIG. 5, for example.

The method 1500 may comprise, in step 1502, obtaining a first configuration defining a plurality of first network resources for transmissions to a first apparatus using a first channel. The first configuration may be as defined above in respect of FIG. 5, for example. Step 1502 may be performed in accordance with step 508 described above in respect of FIG. 5. The first configuration defines the one or more first network resources in one or more dimensions (e.g., a plurality of dimensions). The one or more dimensions may comprise one or more of: frequency, time, space, and transmission code.

Obtaining the first configuration may comprise receiving the first configuration from another apparatus (e.g., from a node in a core network such as the core network 130). Alternatively, obtaining the first configuration may comprise determining the first configuration. Thus, for example, the first apparatus may determine the first configuration in accordance with the method 900 described above in respect of FIG. 9.

The method comprises, in step 1504, obtaining an assignment of one or more reference signals to one or more second network resources from the plurality of first network resources. The assignment is based on first channel estimates for one or more second apparatus (e.g., a plurality of second apparatus) having a same location and first configuration as the first apparatus. The first channel estimates may be as defined above in respect of FIG. 5, for example. Each of the first channel estimates may be associated with a respective network resource in the plurality of first network resources, for example.

Step 1504 may comprise receiving the assignment. For example, the assignment may be received from another apparatus, such as for example, an apparatus in a core network (e.g., the core network 130 described above in respect of FIGS. 1-4).

Alternatively, step 1504 may comprise determining the assignment. Thus, for example, step 1508 may comprise obtaining one or more eigenvectors from a singular value decomposition of the first channel estimates and determining the assignment based on the one or more eigenvectors. The assignment may be determined as described above in respect of steps 510 and 514 described above in respect of FIG. 5, for example.

The method 1500 may further comprise transmitting the assignment of the one or more reference signals to the one or more second network resources to the first apparatus. The assignment may be transmitted in accordance with step 516 described above in respect of FIG. 5, for example.

In step 1506, one or more reference signals are transmitted to the first apparatus using one or more second network resources. The one or more reference signals may be transmitted in accordance with step 518 describe above in respect of FIG. 5.

The method 1500 may further comprise receiving, from the first apparatus, an estimate of the channel. The estimate of the channel may be based on measurement of the one or more reference signals transmitted in step 1508, for example.

Alternatively, the method 1500 may comprise receiving, from the first apparatus, one or more coefficients determined based on measurements of the one or more reference signals. The one or more coefficients may correspond to the one or more coefficients described above in respect of step 520 described above. The method 1500 may further comprise determining, based on the one or more coefficients and the one or more eigenvectors, an estimate of the first channel.

In some examples, the method 1500 may further comprise receiving a request, from the first apparatus, to transmit one or more further reference signals, in which the one or more further reference signals outnumber the one or more reference signals. The method 1500 may thus further comprise, responsive to the request, selecting one or more further reference signals from the plurality of first network resources based on the first channel estimates and transmitting, to the first apparatus, the one or more further reference signals using one or more further network resources.

FIG. 1600 shows a flowchart of a method 1600 performed by a first apparatus according to embodiments of the disclosure. The first apparatus may comprise any suitable apparatus. The method 1600 may be performed by an electronic device, such as any of the electronic devices 110 described above in respect of FIGS. 1-4 or the electronic device 504 described above in respect of FIG. 5, for example.

In step 1602, a first configuration defining a plurality of first network resources for transmissions to the first apparatus using a first channel is obtained. Obtaining the first configuration may comprise receiving the first configuration from another apparatus (e.g., from a TRP such as the TRP 502). Alternatively, the first apparatus may be configured with the first configuration. In a further alternative, the first apparatus may determine the first configuration. Thus, for example, the first apparatus may determine the first configuration in accordance with the method 900 described above in respect of FIG. 9.

The method comprises, in step 1604, obtaining an assignment of one or more reference signals to one or more second network resources selected from the plurality of first network resources. The assignment is based on based on first channel estimates for one or more second apparatus having a same location and first configuration as the first apparatus. Each of the first channel estimates may be associated with a respective network resource in the plurality of first network resources, for example.

Step 1604 may comprise receiving the assignment. For example, the assignment may be received from another apparatus, such as for example, a TRP (e.g., the TRP 502 described above in respect of FIG. 5).

Alternatively, step 1604 may comprise determining the assignment. Thus, for example, step 1604 may comprise obtaining one or more eigenvectors from a singular value decomposition of the first channel estimates (e.g., receiving the one or more eigenvectors from another apparatus or performing the singular value decomposition) and assigning the one or more reference signals to the one or more second network resources based on one or more eigenvectors. The assignment may be determined as described above in respect of steps 510 and 514 described above in respect of FIG. 5, for example.

In step 1606, one or more reference signals received on the one or more second network resources are measured. The one or more reference signals may be transmitted to the first apparatus in accordance with step 518 described above in respect of FIG. 5.

The method 1600 may further comprise determining a channel estimate based on the measurements of the one or more reference signals. The channel estimate may be determined in accordance with step 520 described above, for example.

The method 1600 may further comprise comparing the channel estimate to a criterion and based on the comparison, determining whether to transmit a request for transmission of an increased number of reference signals (e.g., as in the description of determining whether or not the channel estimate is satisfactory in respect of FIG. 5). Thus, for example, the request may be transmitted responsive to determining that the criterion is not satisfied.

The method 1600 may further comprise transmitting an indication of the channel estimate. For example, the channel estimate may be transmitted to a TRP, such as the TRP 502. The indication of the channel estimate may be transmitted in accordance with step 532 described above, for example.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Numerous modifications and variations of the present disclosure are possible in light of the above teachings. It is therefore to be understood that within the scope of the appended claims, the disclosure may be practiced otherwise than as specifically described herein.

What is claimed:

1. A method performed by an apparatus, the method comprising:
obtaining a first configuration defining a plurality of first network resources for transmissions to a first apparatus using a channel;
obtaining an assignment of one or more reference signals to one or more second network resources from the plurality of first network resources, wherein the assignment is based on first channel estimates for one or more second apparatus having a same location and a same first configuration as the first apparatus; and
transmitting the one or more reference signals to the first apparatus using the one or more second network resources.

2. The method of claim 1, wherein the obtaining the assignment comprises:
obtaining one or more eigenvectors from a singular value decomposition of the first channel estimates; and
determining the assignment based on the one or more eigenvectors.

3. The method of claim 2, wherein the determining the assignment based on the one or more eigenvectors comprises:
performing at least a partial pivoted Quadratic Right (QR) decomposition of the one or more eigenvectors to assign the one or more reference signals to the one or more second network resources.

4. The method of claim 2, wherein the obtaining the first configuration comprises:
obtaining a plurality of eigenvectors, wherein, for each of a plurality of configurations, one or more respective eigenvectors from a singular value decomposition of respective second channel estimates for one or more third apparatus having the same location;
selecting the one or more eigenvectors from the plurality of eigenvectors based on at least one of: a rank of the one or more eigenvectors or a sparsity of the one or more eigenvectors; and
identifying, from the plurality of configurations, the first configuration associated with the one or more eigenvectors.

5. The method of claim 2, further comprising:
receiving, from the first apparatus, one or more coefficients determined based on measurements of the one or more reference signals; and
determining an estimate of the channel based on the one or more coefficients and the one or more eigenvectors.

6. A method performed by a first apparatus, the method comprising:
obtaining a first configuration defining a plurality of first network resources for receiving using a channel;
obtaining an assignment of one or more reference signals to one or more second network resources selected from the plurality of first network resources, wherein the assignment is based on based on first channel estimates for one or more second apparatus having a same location and a same first configuration as the first apparatus; and
measuring the one or more reference signals received on the one or more second network resources.

7. The method of claim 6, wherein the obtaining the assignment comprises:
obtaining one or more eigenvectors from a singular value decomposition of the first channel estimates; and
determining the assignment based on the one or more eigenvectors.

8. The method of claim 7, wherein the determining the assignment based on the one or more eigenvectors comprising:
performing at least a partial pivoted Quadratic Right (QR) decomposition of the one or more eigenvectors to select the one or more second network resources from the plurality of first network resources for reception of the one or more reference signals.

9. The method of claim 8, further comprising:
receiving an indication of a number of the one or more reference signals to be received; and
selecting the one or more second network resources from the plurality of first network resources based on the at least partial pivoted QR decomposition and the number of the one or more reference signals.

10. The method of claim 7, further comprising:
determining a sampled channel estimate based on measurement of the one or more reference signals, the sampled channel estimate corresponding to an estimate of the channel at the one or more second network resources;
determining, based on the sampled channel estimate and the one or more eigenvectors, one or more coefficients; and
sending the one or more coefficients to the second apparatus.

11. An apparatus comprising:
a memory storing instructions; and
at least one processor, wherein execution of the instructions by the at least one processor causes the apparatus to perform operations including:
obtaining a first configuration defining a plurality of first network resources for transmissions to a first apparatus using a channel;
obtaining an assignment of one or more reference signals to one or more second network resources from the plurality of first network resources, wherein the assignment is based on first channel estimates for one or more second apparatus having a same location and a same first configuration as the first apparatus; and
transmitting the one or more reference signals to the first apparatus using the one or more second network resources.

12. The apparatus of claim 11, wherein the obtaining the assignment comprises:
obtaining one or more eigenvectors from a singular value decomposition of the first channel estimates; and
determining the assignment based on the one or more eigenvectors.

13. The apparatus of claim 12, wherein the determining the assignment based on the one or more eigenvectors comprises:
performing at least a partial pivoted Quadratic Right (QR) decomposition of the one or more eigenvectors to assign the one or more reference signals to the one or more second network resources.

14. The apparatus of claim 12, wherein the obtaining the first configuration comprises:
obtaining a plurality of eigenvectors, wherein, for each of a plurality of configurations, one or more respective eigenvectors from a singular value decomposition of respective second channel estimates for one or more third apparatus having the same location;
selecting the one or more eigenvectors from the plurality of eigenvectors based on at least one of: a rank of the one or more eigenvectors or a sparsity of the one or more eigenvectors; and
identifying, from the plurality of configurations, the first configuration associated with the one or more eigenvectors.

15. The apparatus of claim 12, the operations further comprising:
receiving, from the first apparatus, one or more coefficients determined based on measurements of the one or more reference signals; and
determining an estimate of the channel based on the one or more coefficients and the one or more eigenvectors.

16. A first apparatus comprising:
a memory storing instructions; and
at least one processor, wherein execution of the instructions by the at least one processor causes the first apparatus to perform operations including:
obtaining a first configuration defining a plurality of first network resources for transmissions to the first apparatus using a channel;
obtaining an assignment of one or more reference signals to one or more second network resources selected from the plurality of first network resources, wherein the assignment is based on based on first channel estimates for one or more second apparatus having a same location and a same first configuration as the first apparatus; and
measuring the one or more reference signals received on the one or more second network resources.

17. The first apparatus of claim 16, wherein the obtaining the assignment comprises:
obtaining one or more eigenvectors from a singular value decomposition of the first channel estimates; and
determining the assignment based on the one or more eigenvectors.

18. The first apparatus of claim 17, wherein the determining the assignment based on the one or more eigenvectors comprises:
performing at least a partial pivoted Quadratic Right (QR) decomposition of the one or more eigenvectors to select the one or more second network resources from the plurality of first network resources for reception of the one or more reference signals.

19. The first apparatus of claim 18, the operations further comprising:
receiving an indication of a number of the one or more reference signals to be received; and
selecting the one or more second network resources from the plurality of first network resources based on the at least partial pivoted QR decomposition and the number of the one or more reference signals.

20. The first apparatus of claim 17, the operations further comprising:
determining a sampled channel estimate based on measurement of the one or more reference signals, the sampled channel estimate corresponding to an estimate of the channel at the one or more second network resources;
determining, based on the sampled channel estimate and the one or more eigenvectors, one or more coefficients; and
sending the one or more coefficients to the second apparatus.
